(19) United States
(12) Patent Application Publication
(10) Pub. No.: US 2022/0339781 A1
(43) Pub. Date: Oct. 27, 2022

(54) Annotation-Free Conscious Learning Robots Using Sensorimotor Training and Autonomous Imitation

(71) Applicant: Juyang Weng, Okemos, MI (US)

(72) Inventor: Juyang Weng, Okemos, MI (US)

(73) Assignee: GENISAMA LLC, Okemos, MI (US)

(21) Appl. No.: 17/511,525

(22) Filed: Oct. 26, 2021

Related U.S. Application Data
(60) Provisional application No. 63/179,977, filed on Apr. 26, 2021.

(51) Int. Cl. B25J 9/16; G05B 13/02

(52) U.S. Cl. CPC B25J 9/163; G05B 13/027

(57) ABSTRACT

This invention presents a new kind of robots that learn in real-time, on the fly, without a need for either annotation of sensed images or annotation of motor images. Therefore, during the process of learning, such annotation-free robots are always conscious throughout its lifetime. This invention grew from the prior art called Developmental Networks that has already supported by its Emergent Turing Machine under-pinning and the maximum-likelihood property. These key properties make it practical to close the loop—from 3D world to 2D sensory images and motor images and back to 3D world. This invention seems to be the first algorithmic-level, holistic, and neural network model for developing machine consciousness. Furthermore, this model is through conscious learning and freedom from annotations of sensory images and motor images. This invention appears to be also the first to model animal-like discovery through general-purpose imitation.

### BACKGROUND OF THE INVENTION

This invention is about conscious learning robots. It specifies two learning modes, sensorimotor training and autonomous imitation, both are free from annotation such as what or where in an image to attend to. The former is basic for understanding robotic and natural consciousness, but it requires temporally dense motor signals (real-time motor-imposed). The latter enables robots to autonomously imitate from sensory observations of demonstrations. Less than a year ago and also specified here, two public disclosures of the inventor [43], [47] presented conscious learning using sensorimotor training, the first algorithmic and holistic method of robotic consciousness. This invention teaches both modes, rooted in emergent universal Turing machines. They represent a major departure from traditional machine learning that requires a set of annotated data set. The analysis here establishes that any static data set (which allows annotation) is invalid because of a lack of sensorimotor recurrence. The autonomous imitation mode drastically reduces the teaching load by enabling robots to autonomously observe, imitate and practice during learning. After autonomous practices, robots gradually become increasingly conscious, robust and creative. This invention is supported by the Developmental Network-2 (DN-2), that is non-iterative, real-time during learning, and maximum-likelihood (ML) optimal conditioned on Three Conditions, (1) a task-nonspecific and incremental learning paradigm, (2) a lifetime teaching experience, and (3) a limited amount of computational resources.

### A. Machine Consciousness

We can trace the origin of modern concept of consciousness to John Locke's “Essay Concerning Human Understanding”, published in 1690, in which he defined consciousness as “the perception of what passes in a man's own mind”.

Merriam-Webster On-line Dictionary defined consciousness as 1. a: the quality or state of being aware especially of something within oneself; b: the state or fact of being conscious of an external object, state, or fact; c: awareness; 2: the state of being characterized by sensation, emotion, volition, and thought: mind; 3: the totality of conscious states of an individual; 4: the normal state of conscious life; 5: the upper level of mental life of which the person is aware as contrasted with unconscious processes.

Christof Koch [13] wrote: “Consciousness is everything you experience. It is the tune stuck in your head, the sweetness of chocolate mousse, the throbbing pain of a toothache, the fierce love for your child and the bitter knowledge that eventually all feelings will end.”

As we can see, the term “consciousness” has been very vague and superficial, without a computational basis that has been mathematically proven to bear the claim of “totality” (Merriam-Webster) and “everything” (Koch), at least in principle. This invention intends to clarify this vagueness. The computational basis utilizes a well-established theory called Universal Turing Machines.

A Dialogue of AMD Newsletters has a topic: “will social robots need to be consciously aware?”, Yasuko Kitano, Conelius Weber & Stefan Wermter, Justin Hart & Brain Scassellati, Axel Cleereman, Juyang Weng, and Guy Hoffman & Moran Cerf made a total of six commentaries. The Dialogue coordinator Jenet Wiles wrote: “Weng [41] takes a different position from the other commentaries, starting from the assertion that all aspects of awareness are tightly interrelated and each cannot function without the others. He calls attention to his brain scale models . . . Integrative systems are needed in modeling, but we should be skeptical of approaches that exclude progress on understanding the biological sub-systems of different neural regions.” The title “Consciousness for a social robot is not piecemeal” in Weng [41] does not mean to “exclude progress” on piecemeal studies of “subsystems”. But rather, it means that we need a holistic approach in order not to get lost in the maze of this extremely rich subject.

This invention further explains why. As we will see from the theory of emergent Universal Turing Machine here, “subsystems of different neural regions” are like a block of computer memory of a particular Universal Turing Machine. When one studies each sub-system of consciousness without a holistic theory about consciousness, he is like one of the blind men in FIG. 1. Many disciplines like biology, neuroscience, psychology, electrical engineering, computer science, mathematics, and physics are related to consciousness. Yes, we often say physics is everything. In my humble personal view, each such traditional discipline is like a blind man when it studies a biological brain in general and its consciousness in particular. If the reader has learned the theory of Universal Turing Machines, he can understand why there are many kinds of Universal Turing Machines and better appreciate that each brain, ranging from fruit flies to humans, is a different Universal Turing Machine. No two brains should be exactly the same!”

FIG. 1 is a simile for us to study only a sub-system of consciousness of a brain without a holistic understanding; each of us is like a blind man touching an elephant, where the blind men are disciplines like biology, neuroscience, psychology, electrical engineering, computer science, mathematics, and physics. Why is each discipline like a blind man? The term “consciousness” has been used in very different contexts. In particular, the term involves extremely complex physical entities, such as brain, body, environment, life and biology. For example, how does a cattle or a human in FIG. 2 learn consciousness so that it navigates autonomously through the hustle and bustle of streets to reach its home daily? Can an artificial machine learn to do the same and much more? The theory of emergent Universal Turing Machine as a computational basis can explain all such complexity and richness in a principled way.

Therefore, for a science of consciousness, we need a concise, but highly precise description of a minimal set of computational mechanisms that have a potential to give rise to natural consciousness and verifiable artificial consciousness. Such a set is not meant to explain every minor detail of all biological systems. This is because any model of biology is inevitably an approximation. However, the inventor argues that we must take a holistic approach. Even though such a holistic approach is still an approximation, it is more insightful than piecemeal approaches.

This minimal holistic set has a potential to make consciousness clearer and deeply understood. Hopefully, the set not only accounts for a wide variety of natural consciousness, but also guides developments of artificial consciousness. By artificial consciousness, the inventor means a robot that displays a repertoire of sensorimotor behaviors that resemble what we call “consciousness”, like that from lower to higher animals.

### B. Sensorimotor Training

The inventor first explains how to teach a robot to be conscious using sensorimotor training mode. Namely, teach the robot by supplying sensory images and motor signals in real time. This mode corresponds to the situation wherein a human drives a car while the machine learns in real time and online through its sensors and its effectors while the driver controls the effectors completely. This sensorimotor mode does not need any human to collect a data set and then annotate it, since everything is learned on-the-fly. The robot is conscious during this learning mode, but it does not have any freedom to try on its own, until the human let the car go free (test session).

### C. Autonomous Imitation

Let us first define annotation.

Definition 1 (Annotation): Annotation here is a human-trainer conducted process during which the human trainer provides information about which components in machine-sensed 2D images (e.g., a binding box) or in the 2D motor image (e.g., the left hand of a humanoid robot) that the machine learner should pay attention to.

It is worth noting that the notion of annotation of motor images is different from the notion of supervising motor images. For example, sensory images are always supervised (by cameras) but supervised images are not necessarily annotated. Likewise, motor images may be supervised by the environment (including human teachers) or by the robot body itself, but motor images are not necessarily annotated.

There have been many papers about imitation learning (see a great survey [9]) but they are all of special purposes, as far as the inventor is aware, not embedded with an emergent universal Turing machine. Furthermore, they all require annotations of sensory images (e.g., which object to learn in an image regardless actions are supervised or not), e.g., see Cresceptron [50], [51] which appears to be the first deep learning for 3D worlds. Weng 2020 [43] established that using motor-imposed training, a DN ML-optimally learns any grounded Turing machine. If the Turing machine is universal, the DN conducts APFGP, without any given tasks, called task-nonspecificity by Weng et al. [53]. This is from 3D scenes to 2D images and motor images—3D-to-2D without annotations in 2D sensory images or 2D motor images.

We need to close the loop in this invention, from 3D scenes to 2D images and motor images and back to 3D scenes—3D-to-2D-to-3D without annotations in 2D. Namely, all signals in the 2D images and motor images and back to 3D scenes are autonomously generated by the machine learner, annotation-free, throughout the lifetime. This is what an animal does almost all the time in life. This is also true with humans all the time in life.

Note, when a human teacher points to an object in a chalkboard, it is not an annotation of the learner's retina, since the entire scene is sensed by a human student without annotation. Instead, the meaning what the teacher wants the learner pay attention to is autonomously figured out by the human learner, not annotated on his retinal images. This invention is the first time to enable annotation-free learning across lifetime.

This invention establishes the generality of a new kind of imitation mechanisms for thoughts [58] and creativity (see Theorem 8), called autonomous imitations. In particular, all published models on imitation, as far as the inventor is aware, require annotation of collected training sensory data based on a given task; but this model is the first that is annotation-free (i.e., no labels are needed for any objects in a cluttered scene being sensed) and without any given task for the machine learner.

This invention presents the generality of a new kind of imitation mechanisms for thoughts [58] and creativity (see Theorem 8), called autonomous imitations.

Human infants can hardly survive without intensive parent care. However, it is not true that they learn from a blank slate. Typically, the lower the animal species, the more innate behaviors are present in the newborns.

First described by zoologist Konrad Lorenz in the 1930s [7], imprinting occurs when a newly hatched animal (e.g., duckling) forms an attachment to the first moving thing it sees upon hatching. Experiments have shown that imprinting appears to be a quick-learning process—learning the appearance of the first moving object, which is usually the mother. However, this moving thing can also be a balloon, or even a stop sign. Imprinting in ducks only occurs during a critical period, starting from 3 hours after hatch, peaked at 15 hours and ends at about 30 hours. Effects of imprinting are lasting, firm, and visually precise.

Human infants do not present imprinting. However, human infants display some innate behaviors too, such as rooting, kicking, and sucking [4]. Infants from 16 to 21 days old, one only 60 minutes old, imitate (a) tongue protrusion, (b) mouth opening, and (c) lip protrusion demonstrated by an adult [20].

Inspired by biological mechanisms of development of brain's motor areas along with the corresponding limbs, developmental robots have two alternatives: (A) Developmental effectors—developing effectors during lifetime, (B) Nondevelopmental effectors—Humans handcraft effectors before inception.

Alternative (A) is necessary for those effectors that are so sophisticated that handcrafted effectors do not allow conscious learning to have the required degree of freedom needed by human-level performance. Vocal effectors that make all possible human sounds, not just speech of a pre-specified prosody, are an example of sophisticated effectors. Wu & Weng 2020 [57] proposed to use Candid Covariance-free Incremental (CCI) Principle Component Analysis (PCA) to develop vocal effectors directly from hearing sounds. This is still different from developing human vocal tract since each human individual has his own unique voice (e.g., Mary's voice is different from John's), but the CCI PCA space can develop representations for any sounds that are heard. Wu & Weng's method [57] has a potential to enable a developmental robot to produce voices that are almost impossible to handcraft for all possible prosody, e.g., creative composition of songs.

Alternative (B) seems to be sufficient for simpler effectors, such as steering, acceleration, and braking, since each effector is one-dimensional and typically changing one effector is sufficient for many cases. This type of effectors can be directly supervised on the motor end, as motor-imposed learning. For example, in teaching a driverless car, supervised motors receive signals from human manual control. However, to approach human level performance, conscious learning is also highly useful for this type of effectors, because such behaviors depend on attention. For example, a human driver enters a major road from a parking lot is because he has already visually checked that there are no approach vehicles within a considerably long distance, beyond the range of commonly used laser scanners for driverless cars. Namely, attention, especially internal attention (e.g., is there a car coming toward me?), still has no effective way to motor-impose. The alternative (B) is limited. For example, humanoid effectors are also one-dimensional each, but coordination of these one-dimensional effectors is necessary to produce human-like behaviors, such as learning or creation of a new kind of dance.

Our main goal here is not just to do something that is ahead of time, but also to solve a currently pressing need to address that existing machine learning methods are weak, too rigid, and not autonomous. By weak, we mean that they mainly have motor-imposed mode or reinforcement mode. By too rigid, we mean that they are not applicable to visual attention, especially language-based attention. By not autonomous, we mean when they learn, what to learn and what to attend, is not autonomously determined by the learner, but are too tedious and slow for a human teacher to tell and annotate in real time.

This invention seems to be the first, as far as the inventor is aware, on conscious learning by autonomous imitation. This subject goes beyond the current three modes of learning, motor-imposed, reinforcement, and unsupervised. In fact, the hidden areas of the Developmental Networks (DNs), used as a supporting learning engine of this invention, is unsupervised—skull-closed. As we will see below, the new kind of learning—conscious learning by autonomous imitation—allows more sophisticated learning subjects, such as sophisticated effectors, visual attention and internal attention (e.g., what to concentrate on) that currently do not have a way to teach at all. Thus, conscious learning by autonomous imitation is beyond the traditional three modes of machine learning.

The remainder of this invention is organized as follows. In the first part, we present a method for robot consciousness that is consistent with animal consciousness. Sec. II overviews Turing Machines. Sec. III outlines Universal Turing Machines. Sec. IV discusses eight (8) necessary conditions as GENISAMA that seem to be necessary for realizing machine consciousness. Sec. V presents the new characterization of consciousness—the capability of Autonomous Programming For General Purposes (APFGP) made possible by GENISAMA Universal Turing Machines. Sec. VI describes Development Networks (DNs) that have a potential to bring about machine consciousness through lifetime development. Section VII explains how GENISAMA Universal Turing Machines enable machine thinking for general purposes. Section VIII outlines motivation which includes emotion. Sec. IX summaries properties of DN. Section X discusses how a DN learns consciousness. In the second part, we present a method for robot autonomous imitation. Sec. XI discusses how a human child consciously learns. Sec. XII discusses an invention of autonomous imitation for conscious learning. The analysis of autonomous imitation is presented in Sec. XIII An example life using both modes is presented in Sec. XIV.

### BRIEF SUMMARY OF THE INVENTION

The new APFGP characterization is now much clearer than existing other characterizations for notoriously vague term “consciousness”. We predict that APFGP would give rise to animal-like artificial consciousness. Future AI will receive a long-overdue credibility. APFGP-based consciousness might be also useful as a computational model for unifying natural consciousness and artificial consciousness, due to its holistic nature backed by GENISAMA Universal Turing Machines.

Furthermore, this invention has established a general-purpose algorithm of autonomous imitation as (1) learning 3D events, (2) creatively generating a program, and (3) carrying out the program. The major difference with the sensorimotor training and autonomous imitation is that with the latter, the learner's motor is free.

Using this autonomous imitation method, artificially created machines will be able to automatically acquire human-like consciousness, from machine infancy to adulthood, with the help of human teacher demonstrations or without, since a real world also demonstrates its facts.

Although we have proved that this process of autonomous imitation by DN is optimal in the sense of maximum likelihood, rediscovery of human knowledge, such as Newtonian physics and Einstein's general relativity by machines requires very long time and much resource. But discovery by machine is possible in algorithm according to this invention. For practical purposes, humans may establish robot schools to teach robots through demonstrations, e.g., robot driving schools that teach robots to drive. The inventor predicts a heavy future demand on high-performance mobile computer engines, real-time-teachable cars, and real-time-teachable robots.

### I. BRIEF DESCRIPTION OF THE DRAWINGS

FIG. 1 is a simile for us to study only a sub-system of consciousness of a brain without a holistic understanding; each of us is like a blind man touching an elephant, where the blind men are disciplines like biology, neuroscience, psychology, electrical engineering, computer science, mathematics, and physics.

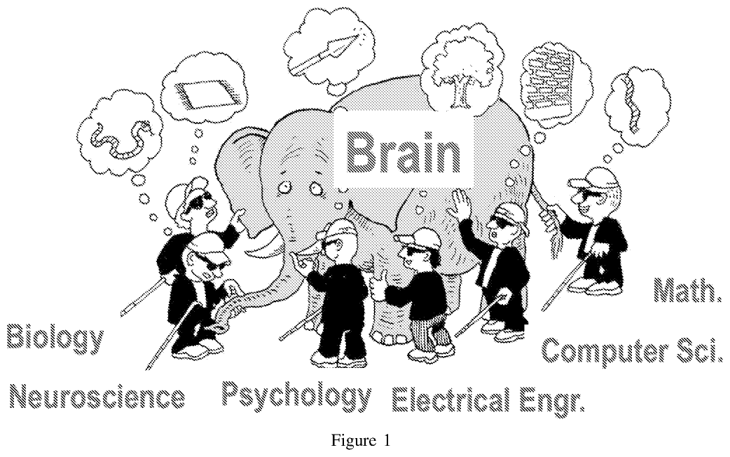

FIG. 2 is a photograph where a cattle (solid ellipse) and a human (dashed ellipse) navigate on a busy street of New Delhi, India where the cattle and the human are conducting conscious learning—being conscious while they learn.

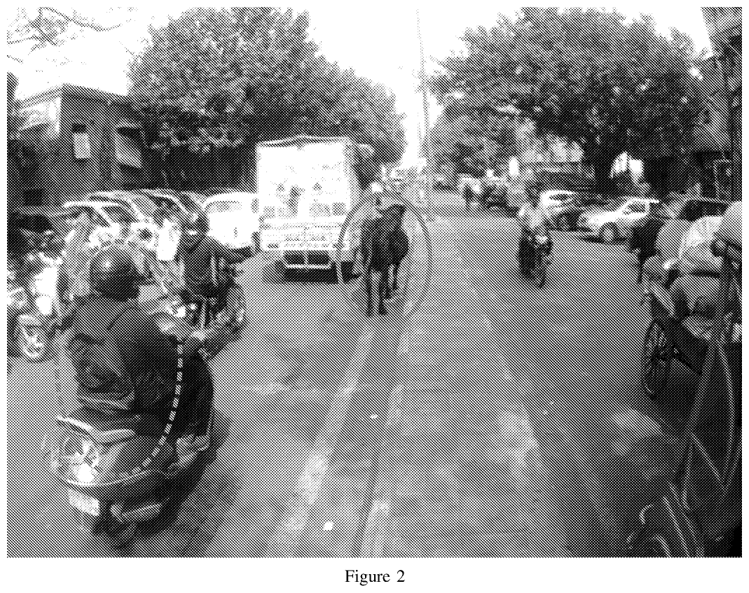

FIG. 3 is an example of Turing Machine for processing strings.

FIG. 4 is an example of Turing machines for computing a function.

FIG. 5 is a conscious learning brain Y modeled by an emergent DN as the two-way bridge of the sensory bank X and the motor bank Z.

FIG. 6 is Concepts for machine thoughts (left) and some examples (right).

FIG. 7 is an illustration for Sensorimotor training abstraction using stage sub-TMs.

FIG. 8 illustrates a setting for a human teacher to teach while kids are autonomous; picture courtesy of britishcouncil.org.ua.

FIG. 9 is an example of abstraction in autonomous imitations of 1 demonstration (solid curves) and m−1 autonomous practices (dashed curves), whose meanings are different from sensorimotor training in FIG. 7 and typically of complexity mk for autonomous imitations in later learning.

FIG. 10 is an example of autonomous imitation; picture courtesy of Jerry Corley at standupcomedy-clinic.com.

### DETAILED DESCRIPTION OF THE INVENTION

### II. Turing Machines

Turing Machines, originally proposed by Alan Turing [36] in 1936, were not meant to explain consciousness at all. However, as we will surprisingly see below, we need the assistance of Turing Machines to understand how consciousness arises from computations by a machine, both natural and artificial, because it explains what is meant by general-purpose computation.

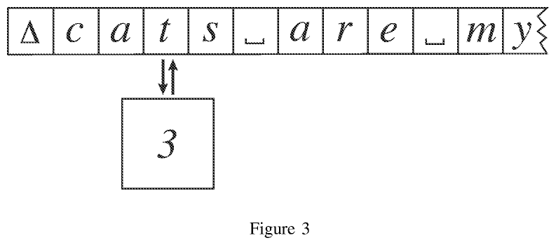

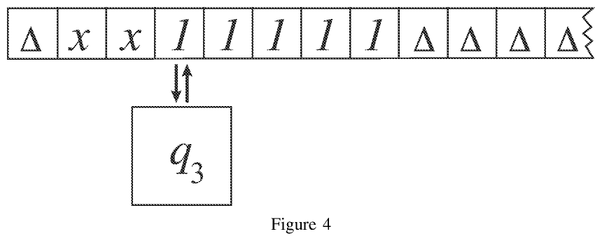

A Turing machine can be used to process strings of symbols as illustrated in FIG. 3 or computing a function as illustrated in FIG. 4. Each cell of the tape bears only a symbol. The controller has a current state (3 in the figure) at each integer time.

Since each digit can be considered as a symbol, FIG. 4 can be considered as a special case of FIG. 3, but since a conscious brain processes sensory and motor vectors (e.g., hand-writing characters and natural images), we can also consider FIG. 3 as a special case of FIG. 4.

A Turing Machine (TM) [8], [18], illustrated in FIG. 3 and FIG. 4, consists of an infinite tape, a read-write head, and a controller. The controller consists of a sequence of moves where each move is a 5-word sentence of the following form:

(q,γ)→(q′,γ′,d) (1)

meaning that if the current state is q and the current input that the head senses is γ on the tape, then the machine enters to next state q′, writes γ′ onto the tape, and its head moves in direction d (left, right, or stay) but no more than one cell away. The TM starts from the initial state q₀ and an input string on the tape. When the state is halt h, what on the tape is the output computed by the TM from the input.

Intuitively speaking, let us consider each symbol in the above 5-word expression as a “word”. Then all such 5-word expressions are “sentences”. Thus, a human-handcrafted “program” is a sequence of such 5-word sentences the TM must follow in computation. Obviously, although such sentences are not a natural language, they are more precise than a natural language in meanings.

After they have tried a variety of small programs, such as (1) checking whether a sequence satisfies a predefined property (e.g., it contains an odd number of symbol b), (2) doing arithmetic computations (e.g., additions, subtractions, multiplications, and divisions); (3) enabling a program to call another program, and many other things, Church and Turing came up with a thesis: A Turing Machine can do any kinds of computations that a paper-and-pencil procedure allows a human to do by hand. This is called the Church-Turing thesis [8], [18].

Weng 2015 [40] proposed that the 5-word vector in Eq. (1) can be conceptually simplified by combining the right side as a new space of state/action, so that the control of any Turing machine can be modeled by an Agent Finite Automaton (AFA) by expanding the state on the left side to the new space of state/action.

The remaining problem then that Alan Turing faced was that such a program is for a special purpose, and such a machine is called a special-purpose computer. The revolution discussed in the next section broke this restriction.

### III. Universal Turing Machines

How can we make the above machine of general purposes? Turing found that we do not need to change the above definition. All we need is to augment the meaning of the input on the tape!

His bright idea is that the tape contains not only the input data for the machine to process, but also an input program for the machine to emulate using the input data!

In his 1936 paper [36], Turing explained in detail how this emulation is done. His main idea is to treat the tape to have two parts, a program and a datum, with a known encoding. The program is a sequence of transitions in Eq. (1). This new kind of Turing Machines is called Universal Turing Machines. A Universal Turing Machine is designed to emulate the input program on the input data and produces the output to the tape. Because the program can be any procedure in the Church-Turing thesis, it has been widely accepted that the universal Turing machine is a model for general-purpose computers. We called it universal because the program on the tape is open-ended, supplied by any users for any purposes. This great idea of universal computers has given rise to today's thriving computer industry.

However, Universal Turing Machines do not explain consciousness. They are still not conscious as we know it. The important rule of Universal Turing Machines in helping us understand consciousness is not known until this invention. Furthermore, traditionally consciousness is a subject primarily of philosophy. This challenging subject has been largely off-limit to AI other than many recent piecemeal discussions.

Weng [40] proved that the controller of any Turing machine is an Agent Finite Automaton (AFA), which is still true for a Universal Turing Machine. Using this result, Weng 2020 [42] proved the Church-Turing thesis.

Furthermore, Weng 2015 [40] proved that a DN learns any AFA ML-optimally. Thus, a DN learns any universal Turing machines ML-optimally.

To see the link between Turing Machines and consciousness, we must break a series of restrictions in Turing Machines, as explained in the next section, so that a new kind of super machines can do APFGP like brains.

### IV. EIGHT REQUIREMENTS FOR CONSCIOUSNESS

The eight requirements below were not well known as necessary for consciousness. At least the APFGP capability requires all of them. However, they are insufficient for giving rise to APFGP without the full Developmental Networks (DN) to be discussed in the next section.

To facilitate memorization, let us summarize the eight requirements in eight words: Grounded, Emergent, Natural, Incremental, Skulled, Attentive, Motivated, Abstractive, or acronym GENISAMA. Let us explain each of them below.

Grounded: Grounded means sensors and effectors of a learner must directly grounded in the physical world in which the learner lives or operates. IBM Deep Blue, IBM Watson, and AlphaGo are not grounded. Instead, it is humans who synthesize symbols from the physical world, and thus shield them off from the rich physical game environments, including their opponents.

Emergent: The signals in the sensors, effectors and all representations inside the “skull” of the learner must emerge automatically through interactions between the learner and the physical world by way of sensors, effectors, and genome (aka developmental program). Because genome is meant to fit the physical world through the entire life, not only for a specific task during the life. For example, fruit flies must do foraging, fighting and mating. Thus, task-specific handcrafting of representation in sensors, effectors, and inside the “skull” is inconsistent to consciousness. The emergence requirement ruled out task-specific and handcrafted representations, such as weights duplication in convolution used by deep learning [49], [51], [25], [17], [29], [15], [12], [16]. Likewise, an artificial genetic algorithm without lifetime learning/development does not have anything to emerge since each individual does not learn/develop in life.

Natural: The learner must use natural sensory and natural motor signals, instead of human hand-synthesized features from sensors or hand-synthesized class labels for effectors, because such symbols and labels are not natural without a human in the loop. For robots, natural signals are those directly available from a sensor (e.g., RGB pixel values from a camera) and raw signals for an effector/actuator. IBM Deep Blue, IBM Watson and AlphaGo all used handcrafted symbols for the board configurations and symbolic labels for game actions. Such symbols are not natural, not directly from cameras and not directly for robot arms.

Incremental: Because the current action from the learner will affect the next input to the learner (e.g., turn left will allow you to see left view), learning must take place incrementally in time. IBM Deep Blue, IBM Watson and AlphaGo appear to have used a batch learning method: all game configurations are available as a batch for the learner to learn. The learner is not aware how it has improved from early mistakes in the lifetime.

Skulled: The skull closes the brain of the learner so that any teacher interactions with the internal brain representation (e.g., twisting internal parameters) are not permitted. For example, Gary Kasparov [30] “accused the Deep Blue team of cheating. The allegation was that a grandmaster, presumably a top rival, had been behind the move.” If this allegation is true, such tempering with Deep Blue during a game violated the skull-closed rule. Likewise, how can the brain be ware of what a neurosurgeon did inside its skull?

Attentive: The learner must learn how to attend to various entities in its external environment—the body and extra-body environment. The entities in the external environment include location (where to attend), type (what to attend) and scale (e.g., body, face, or nose), as well as abstract concepts that the learner learned in life (e.g., am I doing the right thing?). IBM Deep Blue, IBM Watson and AlphaGo did not seem to think “what am I doing?”. The entities in the internal environment includes various aspects of its thoughts. For example, in navigation inside a maze, they include route A, route B, the corresponding distances to the target.

Motivated: The beautiful logic that a Universal Turing Machine has to emulate any valid program does not give rise to consciousness as we know it. By motivation, we mean that the learner must learn motivation based on its intrinsic motives, such as pain avoidance, pleasure seeking, uncertainty awareness, and sensitivity to novelty. A system that is designed to do facial recognition does not have a motive to do things other than facial recognition. IBM Deep Blue, IBM Watson and AlphaGo did not feel real pleasure when they won a game.

Abstractive: Although a shallow definition of consciousness means awareness, full awareness requires a general capability to abstract higher concepts from concrete examples. By higher concepts here we mean those concepts that a normal individual of a species is expected to be able to abstract. Consider movie “Rain Man”: If a kiss by a lady on the lip is sensed only as “wet”, there is a lack of abstraction. A baby cannot abstract love from the first kiss, but a normal human adult is expected to be able to. Thus, abstraction is a learning process.

With the above eight requirements, we are ready to discuss GENISAMA Universal Turing Machines as a new characterization of consciousness.

### V. GENISAMA SUPER UNIVERSAL TM: APFGP

This section describes how a Developmental Network (DN) is capable of learning any GENISAMA Universal Turing Machine, or GENISAMA UTM for short. Such a GENISAMA UTM is further capable of APFGP, which the unique capability that motivated this inventor to propose here as an alternative characterization of consciousness.

First, we need recognize that there are different degrees of consciousness. A baby, a first grader in a primary school, a freshman in a college, and a professor all have different awareness in terms of their richness of consciousness. In other words, consciousness is related to the environment and the age. However, the APFGP capability would allow a baby to be a professor of any discipline, at least in principle.

Second, a dog of 10 years old has a different degree of consciousness than a normal human child of the same age. Namely, consciousness is related to how much computational resources (e.g., the size of the brain) as well as the genome (i.e., developmental programs of each species). Thus, APFGP is bounded by the computational resources and the genome.

Third, if we propose APFGP as a characterization of consciousness, where does a conscious learner's input programs from? A UTM takes a program from the tape along with its data. However, a conscious machine must not just run a UTM, but it should also learn various programs from its environment. That is, the learned programs are from the physical environments, including school teaching.

We consider five entities W, Z, Y, X, X′ at times t, t=0,1,2, . . . , as illustrated in the following Table I. We use discrete times indexed by non-negative numbers to sample a real-time brain, assuming an appropriate sampling rate.

TABLE I
Unfolding Time for APFGP in DN

| Time sample index | 0 | 1 | 2 | . . . |
|---|---|---|---|---|
| Actable world W_{z} | W_{z}(0) | W_{z}(1) | W_{z}(2) | . . . |
| Motor Z | Z(0) | Z(1) | Z(2) | . . . |
| Skull-closed brain Y | Y(0) | Y(1) | Y(2) | . . . |
| Sensor X | X(0) | X(1) | X(2) | . . . |
| Sensible world Wₓ | Wₓ(0) | Wₓ(1) | Wₓ(2) | . . . |

The first row in the table gives the sample times, indexed by non-negative integers.

The second row denote the actable world W, such as the body which acts on W, such as a hand-tool or two shoes.

The third row is the motor Z, which has muscles to drive effectors, such as arms, legs, and mouth to speak.

The fourth row is the skull-closed brain Y. The computation inside the brain Y must be fully autonomous, without intervention from any external teachers [53].

The fifth row is the sensor X, such as cameras, microphones, and touch sensors (e.g., skin).

The last row is the sensible world, such as surfaces of objects that reflects light received by cameras.

The actable world W is typically not exactly the same as the sensible world W′, because where sensors sense from and where effectors act on can be different.

Next, we discuss the rules about how a DN denoted as N=(X, Y, Z) works in W and W′.

Extend the tape of the Turing Machine to record the images from sensors, instead of symbol σ. Let X be the original emergent version of input, e.g., a vector that contains values of all pixels.

Extend the output from the Turing Machine (q′,γ′,d) to be the muscle images from motor Z, instead of symbols. Thus, the GENISAMA Turing Machine directly acts on the physical world.

Unfolding time: We treat X and Z as external because they can be “supervised” by the physical environment as well as “self-supervised” by the network itself. We add the internal area Y to be hidden—cannot be directly supervised by external teachers. Furthermore, we should unfold the time t and allow the network to have three areas X, Y, and Z that learns incrementally through time t=0,1,2, . . . :

$$[ \begin{matrix}Z ( 0 ) \\ Y ( 0 ) \\ X ( 0 )\end{matrix} ] \to [ \begin{matrix}Z ( 1 ) \\ Y ( 1 ) \\ X ( 1 )\end{matrix} ] \to [ \begin{matrix}Z ( 2 ) \\ Y ( 2 ) \\ X ( 2 )\end{matrix} ] \to … \qquad ( 2 )$$

where → means neurons on the left adaptively links to the neurons on the right.

Define c=(x,y,z)∈X×Y×Z as a context. Thus, the transitions in Eq. (2) corresponds to observed context transitions:

c₀→c₁→c₂→ (3)

where cₜ∈X(t)×Y(t)×Z(t), t=0,1,2, . . .

At each time t, the physical world provides a sensory image vector xₜ₋₁∈X(t−1); the machine provides a context (yₜ₋₁,zₜ₋₁) and its “brain” function fₜ₋₁ produces a motor vector zₜ and internal response yₜ as (yₜ,zₜ)=fₜ₋₁(xₜ₋₁,yₜ₋₁,zₜ₋₁)=fₜ₋₁(cₜ₋₁).

1) Innate behaviors: To start with, train the network with a set of “innate” sensorimotor vectors {(x, z)} before birth. For complicated effectors, it is impossible to manually enter z values. E.g., for speaker effectors, use cluster vectors in the PCA space generated from natural sounds. [57]

2) Self-generated behaviors: After the birth, all neurons in every column t use only the values of the column t−1 to its immediate left, but use nothing from other columns. This is true for all columns t, with integers t≥1. Otherwise, iterations are required. Namely, by unfolding time in the above expression, the highly recurrent operations in DN become not recurrent in time-unfolded DN. DN runs in real time without iterations.

Now, we are ready to see how a natural or artificial machine learns consciousness in principle:

The motor area Z starting from Z(0), represents many muscles signals in a developing body, from an embryo all the way to an adult. The larger the developing body, the more muscle neurons are dynamically grown where cell deaths and cell grows both take place. Muscle cells at time t take inputs from the Y area and the Z area in the t−1 column, acting on the environment and also learning from the physical environment mostly through self-supervision—trials and practices.

Likewise, the sensory area X, starting from X(0), also develops within a developing body, also from an embryo all the way to adult. What is different between the motor area Z and the sensory area X is that the latter develops receptors that sense the environment instead of neurons that drive muscles.

Concurrently, the brain Y, starting from Y(0), also dynamically develops, from an embryo all the way to an adult. Each Y neuron at time t gets multiple inputs from all three areas, X, Y and Z, in the t−1 column. Competition among neurons allows only few Y neurons to win and fire. These winner 21 Y neurons at the time t column link to neurons in the muscle area Z in the t+1 column.

As time goes by, the learner looks more and more rule-like, since a GENISAMA Universal Turing Machine emerges as having been proven mathematically in [40]. In the brain this machine autonomously makes an increasingly sophisticated and highly integrated grand program. In the eyes of humans, this learner becomes increasingly conscious. The next section discusses the network that learns the mapping in Eq. (2).

### VI. DN FOR LEARNING CONSCIOUSNESS

A Developmental Network (DN) is meant for consciousness because it is a holistic model for a biological brain, also fully implementable on an artificial machine. The following section presents Developmental Network 1 (DN-1).

### A. DN-1

The hidden Y area corresponds to the entire “brain”. In the following, for simplicity we assume the brain has a single area Y but its past versions have multiple subareas.

1) DN-1 with Y-to-Y connections: The response vector y in the hidden Y area of DN take input from the three areas in the t−1 column to detect hidden features as firing neurons in the t column which is used by Z and X areas to predict the next z and x at the t+1 column, at discrete timey t=1,2,3, . . . :

$$[ \begin{matrix}{z}_{t - 1} \\ {y}_{t - 1} \\ {x}_{t - 1}\end{matrix} ] \to {y}_{t} \to [ \begin{matrix}{z}_{t + 1} \\ {y}_{t + 1} \\ {x}_{t + 1}\end{matrix} ] \qquad ( 4 )$$

where → denotes the update on the left side using the left side as input. The first → above is highly nonlinear because of the top-k (e.g., k=1) competition so that only k Y neurons fire. The second → consists of links from the k firing Y neurons to all neurons on the right side.

Let Z(t) be the vector space corresponding to the symbolic space Q′ at time t. X(t) is the vector space corresponding to the symbolic input space {γ}. Y(t), absent from the corresponding Turing machine, is the emergent (learned) representation of the skull-closed brain that conducts the interpolation of the vector space mapping from time t−1 to time t. Namely the numerical interpolation replaces the rigid look-up table in the traditional Turing machine.

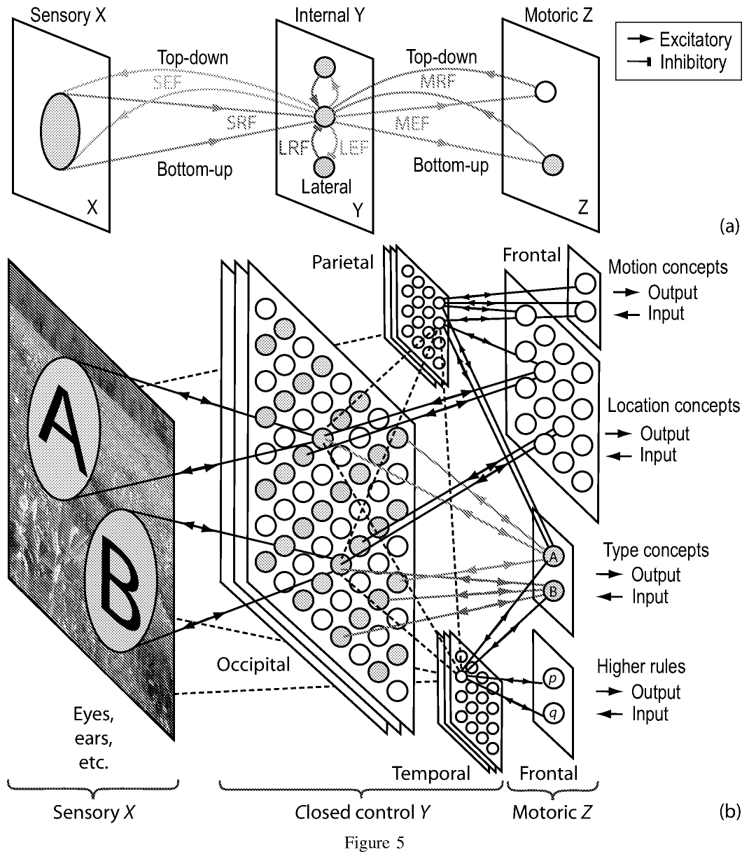

The expression in Eq. (4) is extremely rich as illustrated in FIG. 5 as a schematic diagram of the DN that realizes Eq. (4).

Hebbian-learning based self-wiring within a Developmental Network (DN) generates the control of GENISAMA TM, based on statistics of activities through lifetime, without any central controller, Master Map, handcrafted features, or convolution.

The above vector formalization is simple but very powerful in practice. The pattern in Z can represent the binary pattern of any abstract concept—context, state, muscles, action, intent, object type, object group, object relation. However, as far as DN is concerned, they mean the same—a firing pattern of the Z area.

In FIG. 5 All the connections shown are learned, grown, updated and trimmed automatically by the DN. (a) Each hidden neuron has 6 fields. (b) A schematic structure of the DN. FIG. 5)(a) indicates that each neuron in the hidden area Y of the network has six fields in general: Sensory Receptive Field (SRF), Sensory Effective Field (SEF), Motor Receptive Field (MRF), Motoric Effective Field (MEF), and Lateral Receptive Field (LRF) and Lateral Effective Field (LEF). S: Sensory; M: motoric; L: lateral; R: receptive; E: effective; F: field. But simulated neurons in X do not have Sensory Receptive Field (SRF) and Sensory Effective Field (SEF) because they only effect Y and those in Z do not have Motor receptive Field (MRF) and Motoric Effective Field (MEF) because they only receive from Y.

Eq. (5)(b) shows the resulting self-wired architecture of DN with Occipital, Temporal, Parietal, and Frontal lobes. Regulated by a general-purpose Developmental Program (DP), the DN self-wires by “living” in the physical world. The X and Z areas are supervised by body and the physical world which includes teachers.

Through the synaptic maintenance, some Y neurons gradually lost their early connections (dashed lines) with X (Z) areas and become “later” (early) Y areas. In the (later) Parietal and Temporal lobes, some neurons further gradually lost their connections with the (early) Occipital area and become rule-like neurons. These self-wired connections give rise to a complex dynamic network, with shallow and deep connections instead of a deep cascade of areas. Object location and motion are non-declarative concepts and object type and language sequence are declarative concepts. Concepts and rules are abstract with the desired specificities and invariances.

The hidden area Y(t) corresponds to the “brain” at time t. It consists of a large number of neurons whose response yₜ∈Y(t) is computed from each neuron's receptive fields in X(t−1)×Y(t−1)×Z(t−1).

Learning in Y and Z takes place incrementally in real time so that the mapping fₜ is different for each t.

In general, the Z area has a number of subareas, each of which may correspond to a limb or a concept which has a number of possible concept values but each time has only 1 concept value. Also, in general, each neuron in Y dynamically learns its competition zone in the context space. It fires only when its pre-action potential (match) is among the top-k within its competition zone.

The DN does not use convolution because convolution assumes that neurons' input space X×Y×Z is a shift-invariant which is not true since at least Z is not shift-invariant and therefore Y should not either. Furthermore, the X space is not be shift-invariant either, e.g., a cat is more likely to appear on the ground and less likely on the ceiling. Such statistics is important for attention learning, e.g., during imprinting.

2) DN-1 without Y-to-Y connections: To explain how DN-1 learns any Turing Machine, y to y connections are not needed, because a Turing Machine does have any internal representations and we use y to correspond to each entries of the look-up table. The simplest version is that each Y neuron uniquely corresponds one entry. This gives us the external form of DN transition below:

$$[ \begin{matrix}{z}_{t - 1} \\ {x}_{t - 1}\end{matrix} ] \to {y}_{t} \to [ \begin{matrix}{z}_{t + 1} \\ {x}_{t + 1}\end{matrix} ] \qquad ( 5 )$$

Definition 2 (External form): By external form in Eq. (5), we mean that there are no lateral Y-to-Y connections, compared with the general form in Eq. (4).

The external form Eq. (5) is sufficient to prove that a DN can learn any Turing Machine by memorize one-transition at a time perfectly without any errors as long as there are a sufficient number of hidden neurons [40].

However, the external form does not handle uncertainty in real world very well. Y-to-Y connections that the external form lacks provide hidden features with time-warped and longer temporal contexts which are useful not only to provide temporally more smooth representations, but also internal representations that facilitate machine thinking. Namely, when a machine thinks, it uses not only explicitly taught contexts in the motor area Z, but also hidden features that are not directly taught (i.e., emergent from its own attention and thoughts).

Like the transition function of a Turing Machine, each prediction of zₜ₊₁ in Eq. (5) is called a transition. but now in real-valued vector, without any symbols. The same yₜ can also be used to predict the binary (or real-valued) xₜ₊₁∈X in Eq. (5). The quality of prediction of (zₜ₊₁,xₜ₊₁) depends on how state Z abstracts the external world sensed by X. The more mature the DN is in its “lifetime”’ learning, the better its predictions.

Unlike symbolic states in a Turing machine, a state as vector z E Z emerges autonomously without any humans in the loop of defining and feeding symbols. This is the most fundamental reason for fully autonomous learning so that the machine can become increasingly aware through its own interactions with the physical environment. Therefore, area Z(t) takes input from Y(t−1)×Z(t−1) and its space becomes more and more sophisticated from its “living” experience, probably beyond all the subjects that a programmer has learned.

In the external form, the brain or DN takes input from vector (z, x), not just sensory x but also motor z, to produce an internal response vector y which represents the best match of (z, x) with one of many internally stored patterns of (z, x) as the weight vectors of neurons in the hidden area Y.

3) Competition and learning: Without loss of generality, we consider below that each of the Y and Z areas uses a global top-k (k=1) mechanism which self-picks the winner for the area.

At time t=0, the life inception takes place. z₀ is supervised at the initial state (e.g., representing initial state “none”). x₀ takes the sensory image at t=0. y₀ is a zero-vector to start with. Each neuron i in Y and Z starts with random weights and firing age aᵢ=0.

From t=1, the network starts to update forever. Every neuron i in Y and Z computes their match between its weight w, and input c, as a inner product of two normalized vector \dot{w}ᵢ and ċᵢ:

r′ᵢ=\dot{w}ᵢ·\dot{c}ᵢ.

A perfect match gives r′ᵢ=1. Each area competes by finding the best matching neuron j.

$$j = {arg max}_{i} \{ {r}_{i}^{′} \} .$$

The winner j files at rⱼ=1 and increment its firing age; all other losers i≠j do not fire and do not increment their firing ages.

The value of similarity is the inner product of their length-normalized versions [40]. Corresponding to FA, both the top-down weight and the bottom-up weight must match well for the winner to give a high value as inner product.

The winner neuron updates its weight vector using ML-optimal Hebbian rule:

$${w}_{j} ← \frac{{a}_{j} - 1}{{a}_{j}} {\dot{w}}_{j} + \frac{1}{{a}_{j}} {r}_{j} {\dot{c}}_{j} .$$

We can prove that the above computes the incremental average of all response-weighted inputs [52].

Namely, unified numerical processing-and-prediction in DN amounts to any abstract concepts above. In symbolic representations, it is a human to handcraft every abstract concept as a symbol; but DN does not have a human in the “skull”. It simply learns, processes, and generates vectors. In the eyes of a human outside the “skull”, the DN gets smarter and smarter.

In DN-1, each of multiple Y sub-areas has a static set of neurons so that the competition within each sub-area is based on a top-k principle within each sub-area. Namely, inhibition among neurons within each area is implicitly modeled by top-k competition.

See Weng [42] for more mathematical details about how DN-1 conducts APFGP (Autonomous Programming For General Purposes) and Weng [46] for a more detailed explanation of APFGP meant for cognitive scientists.

4) Random weights result in the same DN-1: Why do random weights result in the same network? When the neuron j fires for the first time its age aⱼ=1, its retention rate

$$\frac{{a}_{j} - 1}{{a}_{j}} = 0$$

and its learning rate

$$\frac{1}{{a}_{j}} = 1.$$

The initial random weight vector only effects whether it is the winner but does not affect the updated weight which must be response-weight normalized input rⱼċⱼ. Yes, the ML-optimal estimate from the first sample is indeed the input sample! The above expression for the winner leads to the average of response-weighted inputs conditioned on the firing of the neuron, which corresponds to the minimum-variance estimate of response-weighted inputs.

Because early age experience is not as important as the latest experience, an amnesic average increases the learning rate

$$\frac{1}{{a}_{j}}$$

and accordingly reduces the retention rate so that the sum of them is still1. See [52] about why such feature vectors from unsupervised learning are called the Lobe Component Analysis (LCA) features and why they are dully optimal in space and in time. By space, we mean that LCA vectors are best distributed in the input space {ċ} so that each is the first principal component vector of the self-organized Voronoi region in the inner-product space. By time, we mean that each feature vector approaches its true principal component vector in the shortest possible time.

In general, k>1 for top-k competition so that a small percentage of neurons fire each time. The resulting distribution of Voronoi regions is smooth, proportional to the probability of being hit by input samples. The same LCA learning mechanism applies to the Z area, but Z neurons could be supervised (imposed) by the teacher occasionally but with autonomous imitations the motor area is emergent without teacher supervision.

### B. DN-2

Developmental Network 2 (DN-2) [54] is different from DN-1 primarily by the following two points.

1. In a DN-2, there is no static assignment of neurons to any sub-areas so that sub-areas in DN-2 automatically emerge, along with their structures, such as sizes and inter-connections between any two sub-areas. A direct advantage of this flexibility is that human programmers are not in the loop of deciding how many sub-areas there should be, the assignment of neurons to each sub-area, as well as their inter-connections (a cascade, a loop, nested, and so on), relieving humans from this highly intractable task. This is because humans do not know such information what should be automatically determined in an ML-optimal way. In other words, a DN-2 can automatically learn to think without being externally supervised through its motor area Z what to think about. Because each neuron has its own learned competition zone in DN-2, the hidden area Y can develop any complex architecture of connections among sub-areas as well as the distribution of neuronal resources, better than hand-crafted cascade in deep CNN networks or handcrafted network in DN-1 based on published cortical anatomy. Every brain must be different, because each has a different lifetime experience.

2. In a DN-2, each neuron has a 3-D location, but neurons in DN-1 do not. The 3D location simulates a biological brain. Because of the need for growing and cutting connections using synaptic maintenance discussed in the next section, the internal representations of DN-2 must be smooth across the 3D location of neurons. Namely, nearby neurons in 3D should detect similar features. Using the 3D locations, the spawn of new neurons is incremental, so that a child is spawn from a parent neuron by inheriting the parameters of the parent neuron. In this way, the DN-2 network incrementally grows an artificial brain that approximates an animal brain in a coarse-to-fine and adaptive fashion.

The computational explanation of further details of DN-2 is out of the scope of this invention since the major novelties of this invention can be explained in terms of the external form of DN-1. The DN-2 should generate better than the corresponding DN-1 as reported in [54] given the same Three Conditions, except that within the first Condition DN-2 is different from DN-1 in agent architecture. The reader is referred to [54] for further details of DN-2.

### VII. MACHINE THINKING

### A. History of Machine Thinking

The history of simulating thinking using computers can be dated back to a paper by Alan Turing in 1950 [37] in which Turing wrote: “I propose to consider the question, ‘Can machines think?’”

Since Turing 1950 [37], 70 years have passed. Much progress has been made in Artificial Intelligence (AI), in both the symbolic school and the connectionist school [39]. However, fundamental blockades of machine thinking persisted. The most fundamental blockade seems to be in treating what machine thinking is, compounded further by a lack of understanding what natural thinking is.

Although well respected by his impressively wide scope of his paper in 1950 [37], Alan Turing did not attempt to answer the extremely challenging original question and instead discussed various contrary views to machine thinking. He suggested what is now called the Turing test, which many researchers believe has inspired and misled [27], [59] many AI researchers. Nevertheless, Turing stated in [37], “we cannot altogether abandon the original form of the problem” (i.e., machine thinking).

Alan Turing predicted in [37], “I believe that at the end of the century the use of words and general educated opinion will have altered so much that one will be able to speak of machines thinking without expecting to be contradicted.” Unfortunately, this situation did not happen by 1999. On contrary, many researchers seem to have intentionally avoided the original machine-thinking question.

As Alan Turing [37] probably agreed, running a computer program on his Turing Machine (TM) [36] that is handcrafted for a given task is hardly animal-like thinking.

Although we have seen books [23], [10], [31] that have “machine thinking” in their book titles, these publications did not explicitly define what they meant by their “machine thinking” and the methods in these books are still non-emergent, not satisfying the machine thinking definition here. As to be explained below, any animal-like machine thinking requires an emergent super-Turing machine.

Over 20 years later than Turing predicted, this invention intends to address this challenging question.

This inventor proposes a definition of machine thinking here, the first ever as far as he knows, that is meant to approach animal-like thinking. In the definition below, we require that a thinking process should be of general-purpose in the sense that any tasks that an agent thinks about are not given by the birth time of the learning agent but must be learned postnatally.

Furthermore, we require machine thinking to be able to acquire any program in the sense of emergent universal super-TM. Namely, the subject of machine thinking is of any nature, open-endedly learned from the living environment after the learner's birth. A thinking process corresponds to the firing of neurons that drive covert actions inside the skull. The any-purpose nature of the inside-skull emergent universal super-TM enables the machine to automatically generate, attend, and generalize covert sensorimotor subjects acquired from cluttered real-world environments. The optimality of DN implies the thinking process is without local minima, constrained by the Three Conditions.

B. Covert vs. Overt States/Actions

We will model that machine thinking involves learning of covert actions, like rehearsals of vocal track actions without activating the glottis.

Definition 3 (Covert and overt): Suppose a motor vector z∈Z consists of a series of sub-vectors z=(z₁,z₂, . . . ,zₙ) where each sub-vector corresponds to an effector. Then, to enable each sub-vector zᵢ to be a concept to think about, zᵢ, i=1, 2, . . . , n, is associated with a pair of covert-overt neurons denoted as (cᵢ, oᵢ). If and only if cᵢ(t)=1, oᵢ=0, zᵢ(t) is covert, corresponding to thinking for sub-vector zᵢ, not displayed to the actable world W_{z} in Table. I. Otherwise, cᵢ(t)=0, oᵢ=1, the sub-vector zᵢ is being displayed to the W_{z}.

The above definition is only an example. Any network structure is allowed as long it enables each motor sub-vector to have a covert mode and an overt mode.

### C. Definition of Thinking

We do not intend to define that running a computer program is machine thinking, as such a definition was not even attempted as early as 1950 by Alan Turing [37]. We intend to define machine thinking to be like what an animal does over its lifetime.

Since all animals think, from fruit flies to humans, we should not define machine thinking in terms of only what an agent can do. As a blind person also thinks, we should not define thinking in terms of a sensory modality. Since a leg-amputated person also thinks, we should not define thinking in terms of a motoric modality. Because a small-brain fruit fly also thinks, like foraging, navigating, fighting, and mating, we should not define thinking in terms of the presence of certain key areas or a capability of a human. Instead, our definition should concentrate on natures of computational mechanisms that have the potential to be true for all lower and higher animals.

Since all animals develop, we first define developmental learning.

Definition 4 (Developmental learning): Developmental learning of a life after the inception time is an online process of lifetime interactions between a skull-closed, task-nonspecific, and incrementally learning network and the extra-skull environment that consists of the extra-skull body of the agent and the extra-body environment that may include teachers. During the interactions, certain changes take place inside the network.

Markov Decision Processes (MDPs) learn but they do not satisfy this definition because an MDP requires skull-open batch clustering to provide a set of symbolic states for the MDP model before a learning process can start, including partially observable MDPs. A human specifies the correspondence between each symbolic state of MDP and the extra-body environment during this batch clustering [24], [14], [33], [28]. This violates the postnatal, online, and skull-close requirements in the definition.

All human-handcrafted graphic models in computer vision violate the task-nonspecific requirement in the definition, since the graphic model is handcrafted based on a specific task.

All convolution neural networks (CNNs) in deep learning violate the task-nonspecific requirement in the definition, because the convolution assumes a shift-invariant property of the environment, as a property of a specific type of tasks.

We first define a simple but tedious training mode of developmental learning, called sensorimotor training.

Definition 5 (Sensorimotor training): Sensorimotor training during developmental learning during a time interval [t₁, t₂], t₁≤t₂, is such that a teacher supervises (imposes) all the motor signals to teach the developmental learner at every discrete times in [t₁, t₂].

It is important to note that the sensorimotor training is not the same as the traditional supervised learning because learning inside the closed-skull of the DN is unsupervised (Hebbian).

Definition 6 (Animal-like thinking): Animal-like thinking is a process of developmental learning inside a neural network during its lifetime (after inception) that have the following then (10) properties.

1) ETM: Conducted by an Emergent Turing Machine (ETM) inside a neural network.

2) General purpose: for any open-ended skills and tasks that are learned from the environment postnatally.

3) Annotation-free: learning directly from a cluttered natural environment, free from annotation for the sensory steams and motor streams. Images from a cluttered world are free from annotations (e.g., no bounding boxes). In the sensorimotor training mode, the motor stream receives raw real-time control signals, not annotations that specify which parts to pay attention to. In the autonomous imitation mode, the motor is totally autonomous, not imposed.

4) Sensorimotor recursive: at any time frame, the next sensory input depends on the current action; therefore, any manually collected static data sets are invalid. Teaching and test sessions cover different time intervals of the lifetime.

5) Motor-imposed or motor-free: some of the effectors are motor-imposed by the teacher.

6) Reinforcers-sparse: reinforcers (pains and sweets) are available but temporally sparse in lifetime.

7) Covert or overt: thoughts are not always immediately displayed to the environment, like “un-voiced”.

8) Thoughts are displayable: may be overtly displayed by corresponding effectors.

9) Thoughts are autonomous: covert, overt, or mix thereof, not dictated by the environment.

10) Conscious: the animal is partially conscious from birth to death, except sleep and power-off, about its skull-external actions and skull-internal thoughts.

Developmental learning in the definition is necessary because every life must be reported, prohibiting the controversial PSUTS (Post-Selection Using Test Sets)—post-selecting only one neural network to report from many randomly initialized neural networks based on their performances on test sets. 1) rules out a traditional symbolic machine whose representation is task-specific handcrafted by a human. 2) excludes just running for a static set of tasks. 3) is necessary since a mother does not annotate data for her child other than real-time interactions. 4) excludes teaching that is physically invalid. 5) allows interactions in real time. 6) avoids temporally dense reinforcers that is impractical. 7) distinguishes thinking from overt actions. 8) excludes running a motor-irrelevant hidden program (e.g., hormone) as thinking. 9) excludes cases where the learner does not autonomously decide when to think, what to think and when and what to display thoughts through actions. 10) excludes unconscious activities from thinking.

D. Thinking with Abstractions

When thinking is taught through sensorimotor interactions, what about “higher” concepts that are involved in thinking? Intuitively, we need to teach why, when, what, which, where and more to think about. The teacher just needs to supervise the corresponding covert cᵢ to fire at 1 or 0 so that whether the display of the corresponding actions is also taught.

Below, we will consider how motor-autonomous learning give rise to higher concepts. The learner needs to experience the real-world results of context cₜ, depending on firing (covert, thinking only) or not (not only think but also executing) and experience the outcome and probably receive a punishment or reward. We need abstraction for generalization.

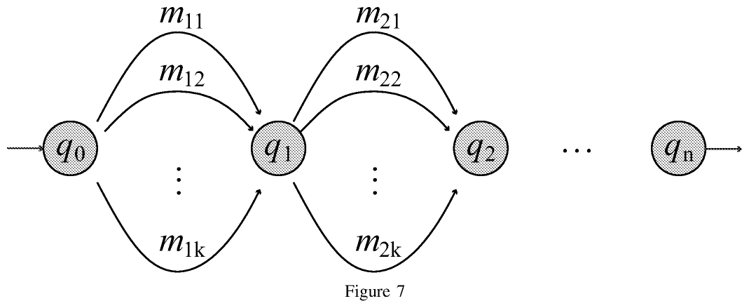

Theorem 1 (Multi-Stage Abstraction): See FIG. 7, where the i-th stage is abstracted by a sub-TM with starting state qᵢ, i=0, 1, . . . n. Each sub-TM has k sequences to learn, each denoted by an arrow. Illustrated in FIG. 7, suppose a global task has n spatial or temporal underlying sub-TMs as stages and each sub-TM requires k sequences to learn to become error free. A brute-force search (without teaching the equivalence of each qᵢ, i=0, 1, . . . , n) requires an exponential number of kⁿ sequences to deal with. In contrast, teaching n sub-TMs, with state equivalences, needs a moderate kn sequences. The uniqueness of the starting state (context for DN) of each sub-TM allows generalization to all kⁿ possible sequences.

Proof: We trace the proof in Weng [40]. Each stage, either spatial search or temporal processing, as shown in FIG. 7, corresponds to a starting state qᵢ in the sub-TM. For this global task, a DN requires k teaching sequences to perfectly memorize the i-th sub-TM. Totally, it has n sub-TM to learn. Thus, the entire DN needs kn sequences to learn perfectly, assuming a sufficient number of neurons. If and only if each state qᵢ is unique, can the DN call the corresponding sub-TM. In contrast, a brute force learner without abstraction of n states must learn an exponential kⁿ number of sequences to be error free.

Note: the number k can take into account the number of possible positions of an object projected onto the retina (image), e.g., for positional invariance. Thus, k can be large. In DN, invariances for location, type, scale, and so on are represented in a gradual and automatically way: Neurons in earlier hierarchy are more concrete in such properties because they have a small sensory receptive field and are correlated with low-level motor neurons (e.g., a pixel-location neuron in Z); neurons in later hierarchy are more abstract because they have a larger sensory receptive field and are correlated with high-level motor neurons (e.g., object-type neuron in Z). Therefore, sensorimotor training is tedious. However, in sensorimotor training, such learning is fully automatic, e.g., when the machine learns while you drive.

We will discuss the more practical autonomous imitation below.

Such abstraction is natural, e.g., after we learned 26 hand-written characters in the English alphabet, we can learn hand-written English words without a need to see all the hand-written combinations of words.

Likewise, some NP-complete problems [8], [18] have a potential to be addressed by a P algorithm if we reformulate the original problem by adding contextual information associated with the original problem, e.g., the Euclidean coordinates of every city in the Traveling Salesman problem [2], instead of cities as abstract points without coordinates. Such additional information provides better “states”.

### E. Chaining of Thoughts as Emergent Sub-TMs

When a train of thoughts takes place in an emergent TM, the train corresponds to a temporal sequence of network activities, sampled at the frame rate in Table. I.

A simple form of chaining is the chaining of overt sensorimotor skills qᵢ sequentially, each of which is identified by time, to realize task transfer [61]—transfer of local overt skills (e.g., drawing a petal) to a global task (e.g., drawing a flower).

In this work about machine thinking, we extend the chaining for time in [61] to chaining by sets of motor concepts, not just time.

Definition 7 (Context Chaining): A chaining of brain activities, that includes covert thoughts and overt displays of actions, is a chaining of emergent sub-TMs based on activated contexts in the DN, as a result of competitions among learned contexts.

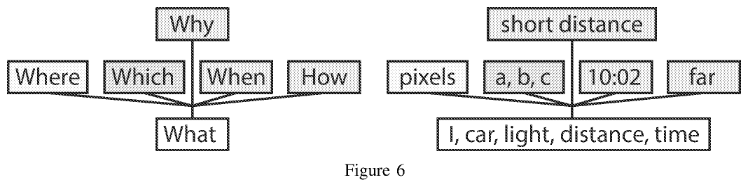

For successful chaining, it is important for the teacher to teach, or the learner to learn or discover, a hierarchy of concepts, like those in FIG. 6. For example, “why” in FIG. 6 (a) represents a purpose or task. Those concepts are represented as motor actions, each of which is represented by a motor vector which can be explicitly taught in sensorimotor training. A neuron in Y typically contains both top-down input t and bottom-up input b. When it wins the competition and fires, the corresponding top-down input t and bottom-up input b are both “attended” by the network, corresponding to the look-up table of the AFA with b as the row and t as the column. Therefore, at each time frame, typically only a subset of the concepts in FIG. 6 are attended (i.e., relevant) and a subset of pixels in the bottom-up input image are attended (i.e., an attended object among many objects in a cluttered natural scene).

Different global tasks may share the same local skills (e.g., collision avoidance). But two different global tasks (e.g., navigation and docking) may not share the same collision avoidance skills. Such a sharing of local skills and exclusion thereof are represented automatically by the set of motor concepts of the emergent TMs that enables each qᵢ in the global task to be unique. We have the following theorem.

Theorem 2 (Winner context): At each lifetime t, multiple k(t) sub-TMs are available, represented by their learned initial contexts {cᵢ,(t)|, i=1, 2, . . . k(t)}, as defined in Eq. (3). Concepts taught before t influence what context wins at time t.

Proof: FIG. 7 shows that given the same context qᵢ, the number of applicable sequences is potentially exponential. Eq. (2) shows that which context wins depends on the concepts in Z(t) taught before time t. Concepts taught influence competing contexts which in turn influence which context wins at time t.

A richer set of concepts taught, as illustrated in FIG. 6, provides a better uniqueness for the DN to automatically find and call an applicable sub-TM based on winner context, to accumulate sharpened calling statistics, and to generalize when it deals with a drastically different global setting with different sensory inputs.

### F. Grand Emergent Universal TMs

Theorem 3 (GEUTM): If each pair of program and data is taught from the environment through interactions with a DN, each pair corresponds to an emergent AFA inside the DN as the control of an Emergent Sub-TM. A Grand Emergent Universal TM (GEUTM) inside the DN is incrementally learned by linking and combining all such Emergent Sub-TMs.

Proof: A teacher, simulated world or a physical world as a “user”, who taught any pair of “program” and “data” as a TM in the form of the agent's sensor X and effector Z of the DN. Because the environment can teach any pair, and each pair is learned as an Emergent Sub-TM. Because calling of each Emergent Sub-TM is based on context, the entire DN corresponds to a GEUTM, following the proof in [40].

It is interesting to see how humans are taught by peers and the physical world as GEUTM-like. Obviously, teaching a pair to a simulated or real robot is intuitive because the real sensors and real effectors are used. The process of teaching requires human intelligence because the real world is cluttered and the teaching process must teach how to attend and generalize in the cluttered world.

Theorem 4 (General-Purpose Thinking): An GEUTM in DN is taught to think in any task if the thinking task has been taught in the form of sensors and effectors of the DN.

Proof: Using the model of machine thinking as covert actions by an GEUTM, the proof follows the proof of Theorem 3. The different here is the actions are covert.

It is worth noting that there is no guarantee that the taught program can always generalize perfectly in a cluttered world. The failures of generalization are important for the learner to observe, to question the learned programs (or rules) and to discover better rules (or new physical laws). Albert Einstein discovered the relativity theory from failures of generalization from Newtonian physics. At least in the invention here, machines seem to be able to conduct scientific discoveries through such machine thinking.

### G. Example of Thinking: Planning

We use planning as an example of teaching DN for planning in a simulation environment. Let us take the experimental examples FIG. 3 in within-one-year prior-art [58] for our discussion in this subsection.

As a process of scaffolding, the teacher in the example has designed a series of visual settings. The agent is first taught the learner to learn walking forward as TM-F. Then, it is taught how to turn right as TM-R, using skills learned from TM-F. Next, it learns how to turn left as TM-L. To teach how to avoid obstacles, the agent is taught TM-A, using learned skills from TM-F and TM-R. TM-F, TM-R, TM-L, and TM-A are called local behaviors. It is worthy noting since each TM corresponds to a subsequence of a lifetime, each TM should contain a transition to return to its initial or “default” state.

After the agent has learned local behaviors, the teacher let it explore different routes from the starting point to a destination as a new task. During this process, the agent learns how to link local behaviors to execute the long task. It is taught with the distance and how to count the distance. These explorations are learned with overt actions. Such explorations of different routes result in the learning of different sub-TMs, TM-R₁ and TM-R₂. For each route, the agent learns a different reward according to the cost of distance, e.g., TM-C₁ and TM-C₂.

Then the teacher teaches covert actions as thinking for the comparison, without actually traversing the two routes. This corresponds to the sub-TM named TM-Co.

Finally, the teacher teaches a long thinking process, that involves covertly running TM-R₁, TM-R₁, TM-C₁, TM-C₁, and TM-Co, which results in TM-R₁ as the chosen plan.

Because we have the general-purpose model known as the GEUTM that learns each sub-TM as a sub-program, the entire learning process for local behaviors, global behaviors, and planning for a global behavior are only an application of the GEUTM, where there is no encoding necessary because the representation of each sub-TM is natural in the motor area of the DN. The human teacher only designs the lessons, but he does not get involved in the programming of the emergent TMs that the DN autonomously learned inside the DN. The environment taught such large TMs while DN automatically integrates them into a grand TM.

### VIII. MOTIVATION

Motivation is very rich. It has two major aspects (a) reinforcers and (b) synaptic maintenance in the current DN model. All reinforcement-learning methods other than DN, as far as we know, are for symbolic methods (e.g., Q-learning [32], [21]) and are in aspect (a) exclusively. DN uses concepts (e.g., recognizing important events like a PhD degree) instead of the rigid time-discount in Q-learning to avoid the failure of far goals (e.g., PhD degree and ethics).

(a) Pains and sweets are reinforcers. Pain avoidance and pleasure seeking speed up learning of important events. Signals from pain (aversive) sensors release a special kind of neural transmitters (e.g., serotonin [5]) that diffuse into all neurons that suppress Z firing neurons but speed up the learning rates of the firing Y neurons. Signals from sweet (appetitive) sensors release a special kind of neural transmitters (e.g., dopamine [11]) that diffuse into all neurons that excite Z firing neurons but also speed up the learning rates of the firing Y neurons. Higher pains (e.g., loss of loved ones and jealousy) and higher pleasure (e.g., praises and respects) develop at later ages from lower pains and pleasures, respectively.

(b) Synaptic maintenance—grow and trim the spines of synapses [38], [6]—to segment object/event and motivate curiosity. Each synapse incrementally estimates the average error β between the pre-synaptic signal and the synaptic conductance (weight), represented by a kind of neural transmitter (e.g., acetylcholine [60]). Each neuron estimates the average deviation β̅ as the average across all its synapses. The ratio β/β̅ is the novelty represented by a kind of neural transmitters (e.g., norepinephrine [60]) at each synapse. The synaptogenic factor f(β,β̅) at each synaptic spine and full synapse enables the spine to grow if the ratio is low (1.0 as default) and to shrink if the ratio is high (1.5 as default).

As reinforcers like pains and sweets are temporally sparse in life and almost absent in almost all intellectual work of a middle class family, we think that an conscious machine is able to cognitively develop without depending on the availability of temporally dense reinforcers at lower levels. The synaptic maintenance enables higher motivation such as praise and respect.

### IX. OPTIMAL PROPERTIES PROVEN FOR DN

If a DN cannot learn quickly like other normal animals, we may have to call it retarded compared to other animals of the same age. We do not want a DN to get stuck into a local minimum either, as many nonlinear systems have suffered.

Weng 2015 [40] has proved for DN-1: (1) The control of a TM is a Finite Automaton (FA). Thus, an emergent FA can learn any emergent UTM for APFGP. (2) The DN is always optimal in the sense of maximum likelihood constrained by the Three Conditions. When there are neurons in the hidden brain to be initialized, the learning is further error-free. This implies that the DN has solved the century-old problem of local minima. The DN framework is mathematically rigorous, not hand-wavy. In particular, the theory of Universal Turing Machines has proved that a Universal Turing Machine of a finite-length tape can learn any tasks, provided that the tape length is sufficiently long, but finite [19]. Note, rules of any purpose are learned from the external physical environment. For more detail, read [40].

The corresponding proofs for DN-2 are available at [54].

In summary, every DN, DN-1 and DN-2, is optimal in the sense of maximum likelihood, proven mathematically. Put intuitively, all DN are optimal, given the same learning environment, the same learning experience, and the same number of neurons in the “brain”. There might be many possible network solutions some of which got stuck into local minima in their search for a good network. However, each DN is the most likely one, without got into local minima. This is because although a DN starts with random weights, all random weights result in the same network.

However, this does not mean that the learning environment is the best possible one or the number of neurons is best possible one for many lifetime tasks. Search for a better educational environment will be a human challenge for their children, both natural and artificial kinds.

### X. CONSCIOUS LEARNING

A formal training in Universal Turing Machines seems necessary in order to understand the above highly mathematical material, such as Table I and Eq. (2). A self-teaching process of automata theories could be insufficient. The following presents examples for an analytical reader who has had a formal training in Universal Turing Machines.

Suppose each time frame in Table I represents 20 ms, namely the real time is sampled at 1000 ms/20 ms=50 Hz. Thus, the frames in Table I and Eq. (2) run very fast in real time, as a real physical learner interacts with its physical environment via its sensors and effectors. Let us consider the following two assumptions.

Assumption 1 (Supervised motor): At each time t, a teacher supervises zₜ of the learner so that zₜ predicts correct state/actions for a Universal Turing Machine, for all times t=0, 1, 2, . . . .

This assumption is relatively easier to understand but not always practical since it is not always possible for a teacher to always supervise in real time at 50 Hz.

Assumption 2 (Unsupervised motor): At each time t, the learner self-generates zₜ so that zₜ approximates state/actions for a Universal Turing Machine, for all times t=0, 1, 2, . . . .

This assumption is more practical but, like a child, requires more practices, through trials and errors, to improve its approximation of states/actions. The motivational system plays an important rule, such as pain avoidance and pleasure seeking explained in Section VIII. This is a process called scaffolding [56] where early-learned simple skills assist the learning of later more complex skills.

What is scaffolding and why is it powerful? In visual learning, the early learned skills of recognizing a person's face facilitates later learning of recognizing his body. In auditory learning, the early-learned skill of recognizing phonemes facilitates latter learning of words. In language learning, the early learned skills of recognizing words like “have” and “time” facilitates latter learning of phrases like “have time”. The learning of simple skills like English during early life facilitates later learning of algebra and calculus in later school life. Such a learning process of algebra and calculus may be through classroom teaching during which sensory inputs (visual, auditory and language) about the skills for algebra and calculus are translated into skills of conducting vision-guided, audition-assisted, language-directed writing procedures of algebra and calculus. This leads to the following definition.

Definition 8 (Conscious learning): The conscious learning by a biological or artificial machine is that the learner is conscious throughout its lifetime learning—it bootstraps its consciousness, from being little conscious, to increasingly conscious, to maturely conscious.

The term “little conscious” is species specific. For lower animals, inborn behaviors that are reflexive can be called little conscious.

As we can see from the above discussion, scaffolding not only facilitates learning skills from simple to complex, but is also essential for a machine to bootstrap its consciousness—being conscious during learning, so that it consciously attends to important events and applies early learned conscious skills to learning later more complex conscious skills.

In practice, a real learning system interacts with its environment, which contains different teachers at different ages. The mother, the father, schoolteachers, colleagues, and physical facts are all teachers. This process of interactions amounts to a lifelong process of scaffolding, making Assumptions 1 and 2 true at different times, for different sensory modalities and different motor modalities.

Regardless what environment a learner has, the acquisition of skills, from simple to complex, throughout a lifetime requires that the skull-closed brain to be fully automatic inside the skull, off-limit to manual intervention by any human teacher based on the test set. In [48], [45], [44], Weng pointed out that (1) in symbolic AI, a programmer handcrafts a set of symbols and (2) in connectionist AI, many neural networks require handpicking features in the hidden areas. Weng argued that both (1) and (2) require the human programmer to know the test set and, therefore, amount to PSUTS (Post Selection Using Test Sets).

### XI. CONSCIOUS LEARNING CONDITIONS

### A. Definition

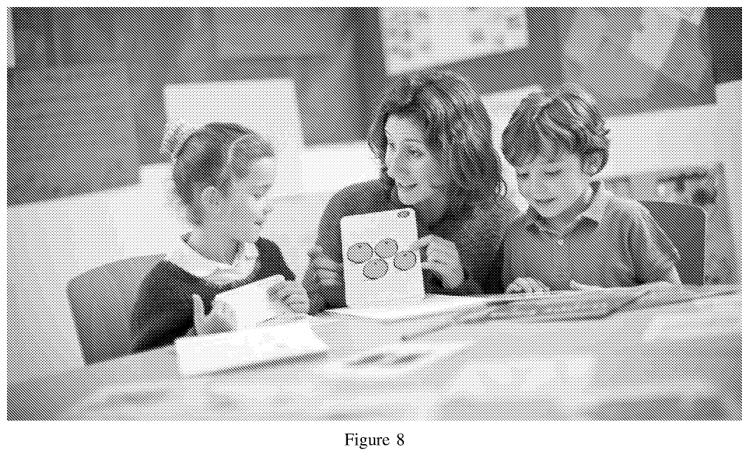

Shown in FIG. 8 is a setting of conscious learning. A developmental robot may start from birth and live to over 21 years. Although robot sitting is not exactly the same as kindergarten teaching in FIG. 8, let us define some conditions of conscious learning in computational terms.

Definition 9 (Conscious learning conditions): Conscious learning satisfies the definition of animal-like thinking and the following eight (8) properties: GENISAMA (grounded, emergent, natural, incremental, skull-closed, attentive, motivated, abstract), plus two more: (1) life required degree of real-time, (2) conducted by a general-purpose learning engine capable of learning an emergent universal Turing machine.

The animal-like thinking is necessary since consciousness requires thinking. See [43] for reasons for requiring GENISAMA. (1) is needed for human sensory refreshing rate; otherwise the learner is not aware of the life required fast change in the physical world, probably using a filming device. (2) enables the learner to learn any practical concepts and procedures including Autonomous Programming For General Purposes (APFGP) directly from the physical world. Unlike a universal Turing machine, APFGP in DN learns programs directly from the physical world, using by the sensorimotor training mode or the autonomous imitation mode.

### B. SEB Learning Modes

Consider questions: Supervised internal representation? Effector imposed? Biased sensors used? We have a new definition of 8 learning modes as SEB learning modes:

Definition 10 (SEB learning modes): Let seb be represented by a binary number. s=1: skull-internal representation is partially human supervised, s=0 otherwise; e=1: effectors are imposed, e=0 otherwise; b=1: biased sensors (pain, sweet, instead of unbiased sensors like cameras and microphones) are used; b=0 otherwise. Then, the seb binary codes have 8 patterns, seb=000, seb=001, . . . , seb=111.

Therefore, s=1 corresponds to symbolic representations—human crafted task-specific representations, such as SLAM, Markov Decision Process (MDP), Partially Observable MDP, Graphical Models, as well as neural networks that have human handcrafted features such as human selected features in CNN and LSTM. s=0 corresponds to DN and other inside-skull-unsupervised networks (e.g., some reservoir computing).

The case e=1 is effector specific, which may mean a human teacher imposes the effector for teaching purposes, such as the sensorimotor training mode; but e=1 constraints are also available from the physical world. E.g., limb effectors of kids in FIG. 8 are constrained by the table and chairs.

Note that eb in seb has four binary patterns, eb=11 is a combination of motor-imposed learning and reinforcement learning, which is not common in traditional machine learning but allowed.

We are interested in seb=000 during which autonomous imitation takes place. seb=010 and seb=001 only occasionally occur like the setting in FIG. 8.

The inventor argued in [43] that there are some fundamental limitations in current Machine-learning methodology fed by static datasets: (1) The non-sensorimotor recursive nature of any datasets. (2) Post Selection Using Test Sets (PSUTS), which trains kn networks, where k is the total number of combination of hyper parameters and n the number of trials for random weights of neurons. Because of a lack of Turing machine mechanisms in Convolution Neural Networks (CNNs) trained by error-backprop, the luckiest network among kn that happens to fit the test sets best is not likely to fit a completely new data set well. (3) A lack of conscious learning further explained below.

As shown in FIG. 8 or in a driver-less car, the environment is cluttered which contains multiple objects. At any time, only relatively few items (e.g., the drawing that the teacher shows in FIG. 8) are related to the current task that needs to be attended to. Typically such related objects occupy only a small part of a grabbed image. Other objects are distractors. However, distractors must be sensed too since they are used for determine what to attend. A new setting can be very different from all the settings learned, where a learner must correctly find appropriate objects to attend to and learn them from a large number of distractors. Such skills of attention require conscious learning.

In annotation common in the computer vision community, a human segments the object to learn by drawing a polygon around the contour of the object [51] or a rectangle [26]. Such manual segmentation is not only impractical for real-time tasks (too slow and too many), but more fundamentally, such statically trained systems are not conscious, unconscious about real cluttered environments that they are supposed to deploy into. This unconsciousness results in highly brittle systems. Using this methodology, driverless cars could not be ready for wide deployment.

A more promising way is to set the learner free into deployed settings, like the two kids in FIG. 8, so that they learn from his own actions including attention actions.

One concern is that the amount of computational power is prohibitive due to the real world complexity. Different species have brains of different sizes in terms of number of neurons. Instead of PSUTS that is slow and uses a huge amount of computational resources, let us use a limited hardware that can run in real time (e.g., a GPU based phone), what can it do for open-ended environments through its lifetime? A fruit fly has about 100 k neurons. It does consciously learn to acquire simple to complex skills through scaffolding [55]—early-learned skills assist learning later skills. This methodology seems more practical with DNs since they are free of local minima without a need for PSUTS.

A DN computes the ML-optional emergent Turing machine, which is explainable. In other words, we only need to train one single network for each lifetime experience.

### C. Why Autonomous Imitation?

A human senses the 3D world using its sensors whose receptors lie in a 2D sheet (retina, cochlea, skin). For general applicability of our method, we do not need to model the physical transformation from the 3D world to a 2D sensor since our baby brains must work before they have a chance later in life to learn physical laws that govern the mapping from the 3D world to the 2D receptor image.

Sometimes, this mapping can be slightly changed, such as wearing a new pair of glasses. But a human can learn quickly and get used to the change. In summary, there is no need to calibrate the transformation from 3D to the 2D.

There are three major reasons to model development of brains in terms of autonomous imitation.

First, imitations are 3D-to-2D-to-3D. A 3D-world event can be a spatial 3D event (e.g., counting how many cars there are in a cluttered scene), a temporal 3D event (e.g., finding how an attended car moves within a time interval), or a combination of space and time (e.g., how a car collision happened). The sensory input to a learner is basically 2D (e.g., receptors in eyes and hair cells in cochleae). Autonomous imitations enable a learner to sense a 3D event using its 2D sensors and convert the 2D sensory information into its effectors that generate another but similar 3D event.

Second, autonomous imitations show whether the learner understands the demonstration of a 3D event. The criteria for the similarity of a successful imitation depend on the nature of the teaching and the age of the learner: They differ greatly from a baby who imitates a child play to a college student who does home work to imitate calculus procedures demonstrated in a calculus class.

Third, autonomous imitations reduce teaching complexity compared to motor-supervised training as we analyze below.

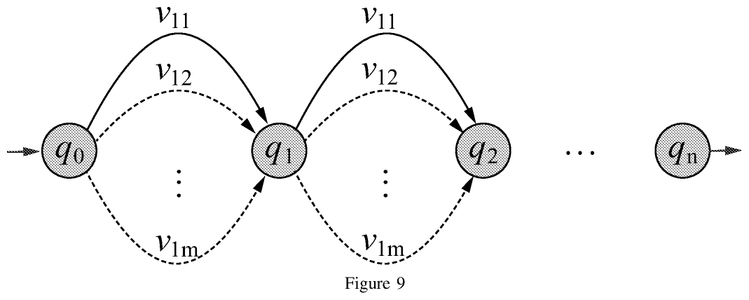

Similar to FIG. 7 which is for sensorimotor training, now refer to FIG. 9 which is for autonomous limitation from demonstration. Let us analyze the imitation complexity. Suppose teaching a 3D task consisting of a number of time-stages, where each stage spans one or multiple discrete times in Eq.(3). Let a 3D event have n stages. Within each stage, the learner must deal with m variations of stage-to-stage transitions (e.g., due to sensory variations). Note that m here is for autonomous imitation, different from k in FIG. 7 which is for sensorimotor training. Typically, m is much smaller than k, because we assume that a robot that can autonomously imitate is more mature than a robot that is taught by sensorimotor training.

Let n=10 and m=10. If we use a brute-force data-fitting network, the learning task requires mⁿ=10¹⁰=1 billion of event samples! Alternatively, if we use motor-imposed training for each stage using human imposed-motor, the same task requires mn=10×10=100 teaching examples, 10 teachings for each of the 10 stages. Finally, suppose that the machine is able to autonomously imitate using correct states in contexts, the teacher only needs to demonstrate n stages, one example for each stage. Then, during a later homework session, the learner is able to autonomously imitate for each of the remaining m−1=9 variations without a need for the teacher to demonstrate more. Thus, it autonomously generalizes to real-life experience of potentially mⁿ=10¹⁰=1 billion cases! Let O(f(n)) denotes the upper bound of the growth rate of function f(n). Our reasoning leads to the following theorem.

Theorem 5 (Imitations reduce teaching complexity): Suppose a task consists of n stages, where each stage consists of dealing with m variations. A bruit force data fitting requires an exponential number O(mⁿ) training samples and O(mⁿsb) computations during training where s is the average receptive field size of neurons and b the number of neurons in the “brain” network. Motor-imposed teaching for an emergent Turing machine in DN requires O(mn) motor-supervision and O(mnsb) computations during training. Autonomous imitation by conscious learning requires O(n) demonstrations and O(mn) autonomous practices as well as O(mnsb) computations during demonstrations and autonomous practices.

Proof: We have already proven above for the training complexity. Let us deal with the number of network weights. Each network update requires O(sb) computations. The number of computations during learning is the number of samples times the number of computations in the network. Thus, we have O(mⁿsb) for brute-force data fitting, O(mnsb) for motor-imposed training with abstraction, and O(nsb) for n demonstrations plus mnsb−nsb=O(mnsb) practices through autonomous imitations during homework.

The most important concept in the above theorem is the reduction of teaching complexity. For n=10, m=10 demonstrations in teaching mean a reduction of 90% of teaching complexity from motor-supervised learning, because the teacher is absent during practices. Autonomous imitations during practice should give a superior generalization power because a real world may have more realistic variations for practice.

Because autonomous imitations directly interact with the real world, they do not need a human teacher to collect a static and large data set and then hand-annotation this data set.

Psychologists are amazed by how fast a child learns new sentences without much teaching [34], [22], [35]. The inventor presents here a computational account in Theorem 5 other than what is called “language instinct” by Steve Pinker [22].

Can a DN machine learn to autonomously imitate a teacher but the DN program itself is not allowed to explicitly imbed any task-specific mechanisms for imitation? This is the interesting subject for the next section.

### XII. AUTONOMOUS IMITATIONS

The inventor argues that APFGP is a computational characterization of consciousness defined by common dictionaries. Imitation is an intuitive term for conscious learning.

Suppose W(t) denote the 3D space of real world t=0, 1, 2 . . . . A sensed event from time t₀ to t₁, t₀≤t₁, is an ordered sensory image sequence x=(x(t₀),x(t₀+1), . . . , x(t₁)), sensed from the 3D event from the real-world space E=(W (t₀)×W (t₀+1)× . . . ×W(t₁)) . Let us formally define autonomous imitation.

Definition 11 (Autonomous imitation): A conscious learning agent conducts autonomous imitation using memory learned from its environment if its action sequence imitates a 3D event from the environment and a human expert judges that the action sequence indeed resembles the 3D event. The imitation is autonomous if the agent's effector is not motor-imposed.

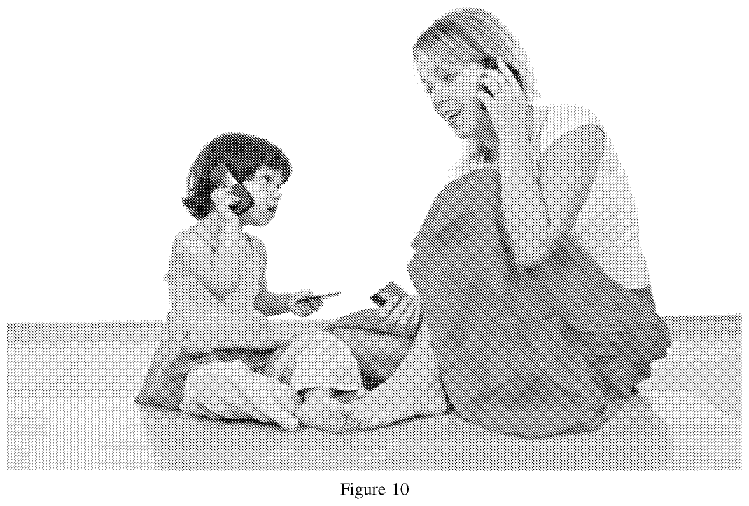

FIG. 10 shows an example of autonomous imitation. The 3D event is “A hand places a phone on an ear”. The child sees that and her action sequence caused “a hand places a phone on an ear”.

Definition 11 does not specify how the 3D event is projected onto the agent's sensors. Neither does it specify how the agent's effector sequence is judged to resemble the 3D event. Such detail is filled according to the goal of teaching. Definition 11 does not forbid a use of biased sensors to motivate the learner. In animal training, use of reinforcers (e.g., food or touch) is typical.

If the imitation only involves external effectors, motor-imposed teaching is still possible. In FIG. 10, e.g., the teacher could place a phone into the child's hand and then pull the child's hand up so the phone touches child's ear. Then, the imitation is not autonomous.

However, if the imitation involves skull-internal behavior such as attention (e.g., attention to phone), motor-imposed training is not directly available. A human teacher may use body signs or verbal languages as part of 3D event to facilitate the emergence of imitative behaviors. For example, the teacher could say, “notice the phone” or simply “phone”.

### XIII. ANALYSIS

A conventional AI method, widely practiced in computer vision, is to hand-label every concept required. For the “where” concept. the label would be a pair (i, j) for i-th column and j-th column in every image. For the “what” concept, the label would be a class label, such as “hand, phone, ear”. These labels are imposed to the motor area of the agent. This type of training, called motor-imposed training with seb=010, is not consistent to autonomous imitation, as we further analyze below.

The power of conscious learning is rooted in the methodology to set the machine learner free—let it freely act like a human child. For example, during early infancy, the motor area of the machine is driven by a set of innate-behavior vectors. For complex effectors like voice synthesis, these innate vectors may correspond to phonemes from which the PCA space is developed as an artificial vocal tract [57]. For vision-guided driverless cars, these innate vectors may correspond to “pull a horse” as we will see below. In the following, we analyze the effects of setting the learner free by demonstrating skills according to the skill level of the learner.

a) Single-motor imitation: A single motor involves a single segment of the body, such as a vocal tract, a hand, an upper arm, a lower arm, a foot, a lower leg, an upper leg, etc. For driverless cars, individual motors include steering, acceleration, braking, etc.

When each Z vector zᵢₙₙₐₜₑ is innately firing in the motor, the corresponding physical effect as the corresponding 3D event is simultaneously sensed by the learner's sensors as a sensory event x_{effect}, only slightly delayed. If zᵢₙₙₐₜₑ changes slowly in time (e.g., vowel phoneme or a slow motion event), the sensory event x_{effect} also changes slowly in time. After learning x_{effect}→zᵢₙₙₐₜₑ, later zᵢₘᵢₜₐₜₑ is invoked from a similar sensory event x_{sound} as automatically self-generated motor zᵢₙₙₐₜₑ from x_{sound}, namely, the “mirror neurons” of x_{sound}. This animation process in time is called the imitation theorem:

Theorem 6 (Early imitation): Early practiced action zᵢₙₙₐₜₑ is automatically invoked later from an associated sensory event x_{effect}:

$${z}_{innate} {\to }^{phy} {x}_{effect} {\to }^{y} {z}_{innate} ⇒ {x}_{effect} {\to }^{y} {z}_{innate} \qquad ( 6 )$$

Proof: The proof follows from the above reasoning. In the above expression, “phy” is stands for physics; y means internal hidden neurons in Y. ⇒ means the left side practice causes later autonomous imitation on the right side.

Note, the sensory event x_{effect} on the right side can be from another person. For example, when an infant A innately cries right after birth, the firing motor neuron zᵢₙₙₐₜₑ=z_{Acry} is the motor of crying sounds of A. When another infant B cries, the similar crying sounds of B, with x_{Bcry}≈x_{effect}, are sensed by A that causes A's crying motor neurons to fire. That is, after hearing other baby crying, infant A also cries—autonomous imitation.

The A's crying is not necessarily exactly the same as B. Through later experience of many imitations, refined generalizations in the brain take place as context transitions based on learned emergent Turing machine. These generalizations are increasingly invoked by attended sensory features and motor concepts and become more sophisticated to enable imitations to involve multiple sensory objects and multiple body parts/concepts.

b) Multi-motor imitation: A multiple-motor event involves more than a single segment of the body, such as dancing by a humanoid robot and braking while making a turn by a driverless car.

A human teacher demonstrates a multi-motor event, such as dancing. Each body component of the teacher has individual mirror neurons established above. The sensory effects of every body component are sensed by the neural network to excite the corresponding mirror neurons. Thus, attention to multiple sensory components takes place by the firing of multiple motor neurons, either through sequential attention or concurrent joint attention. Multi-motor imitations emerge automatically due to pattern learning in DN.

Theorem 7 (Multimotor imitation): A multimotor imitation capability is a later-time extension from the early imitation theorem, by extending the zᵢₙₙₐₜₑ to an early practiced multimotor action zₘᵤₗₜᵢ and requiring more fine-tuned neurons yₘ in the neural network that tune their receptive fields to more relevant sensory objects xₘᵤₗₜᵢ that are also sensed from multimotor concepts of the event.

$${z}_{multi} {\to }^{phy} {x}_{multi} {\to }^{{y}_{m}} {z}_{multi} ⇒ {x}_{multi} {\to }^{{y}_{m}} {z}_{multi} \qquad ( 7 )$$

If the autonomous imitation is for a long sequence of event, the above arrows indicates triggering the starting context of the corresponding emergent Turing machines that display the event.

Proof: From Eq. (6), let zᵢₙₙₐₜₑ be replaced by zₘᵤₗₜᵢ and x_{effect} by xₘᵤₗₜᵢ. Assuming that early experience has enabled the neural network to fine turn its hidden feature neurons using Hebbian learning based LCA plus synaptic maintenance by cutting off irrelevant sensory inputs from X and irrelevant concepts inputs from Z. Thus, replacing the symbol y in Eq. (6) is by yₘ, we have the above expression.

Theorem 6 can be verbally summarized as “practice makes perfect”. Eq. (7) tells us: let the learner try zₘᵤₗₜᵢ first. For example, to learn how to drive cars one must try driving.

c) Condition to start imitation: The condition in our above discussion is sensory xₘᵤₗₜᵢ, which can represent also time. Time is a concept that the learner can learn through imitation and counting. The speed of context change of “where-and-what” of each 3D object, represented as last “where-and-what” in zₜ₋₁, the internal context yₜ₋₁, and the current sensory vector xₜ₋₁. The next context zₜ represents the change, or motion, of the attended 3D object. Thus, the concept of motion or time emerges as the condition to start imitation.

The starting time of imitation could be triggered by an environmental cue, e.g., teacher's nod or the setting for doing homework is ready (e.g., clock).

d) Imitation of internal attention: Imitation for internal attention is not motor-imposable, since there is no overt motor that corresponds to the attention. Suppose the teacher demonstrates “notice pedestrians”. However, it is impractical for the teacher to motor-impose “pedestrian” since vocal tract is inside the body, not imposable. However, if the learner has spoken “pedestrian” while its attention is on pedestrian, teacher's demonstration “pedestrian” (e.g., speak) causes “pedestrian” motor in the learner to fire. The firing boosts internal Y neurons through top-down connections so that the learner attends to pedestrians. This is similar to the above example of baby crying imitation as an example of Thereon 6, but here the motor is not cry, but firing of covert motor “pedestrian”. Let us call this type of internal limitation language-directed imitation of internal attention.

e) Generality and creativity of imitation: An imitation of 3D events involves attending to a few concepts and their relationships but exchanging some associated concepts, all of which have been learned by the conscious learner represented in its motor area.

In FIG. 10, three concepts are attended to: hand, phone, and ear, and two concept-relationships are attended to, phone-in-hand and phone-at-ear. Two concepts are associated as human type but substituted, “I” and “teacher” are associated as humans but “I” substitutes “teacher”.

Using the generalization reasoning above, we can see that imitations are generally applicable to any observed events.

We have the following interesting theorem about generality and creativity.

Theorem 8 (Generality and creativity of imitation): Thoughts by a natural or artificial agent via autonomous imitations of 3D real-world events are of general purposes per universal Turing machines. If the imitation result is judged considerably different but creative, such autonomous imitations correspond to creativity of the agent in the judge's eyes.

Proof: Conscious learning in Definition 9 involves learning a universal Turing machine modeled as context transitions in Eq. (3). According to Theorem 7, an imitation composes a program as context transitions, regardless of a computer program or a task plan, which involves attending to some components in contexts, but substituting some associated concepts. According to Eq. (7), this process includes learning to convert a 3D event (e.g., what is taught in a college class) sensed as a sequence of 2D sensory images in the form of xₘᵤₗₜᵢ and then to create a program as a sequence of motor signals in the form of zₘᵤₗₜᵢ, and finally to carry out the program back to the real world. Such compositions of programs correspond to human thoughts [58]. Therefore, the context transitions in Theorem 7 are of general purposes per universal Turing machines. The real-world result of the imitated program might not be a 100% duplication of the original 3D event and may be considerably different due to a variety of limitations in the real-world environment and the agent. If the difference is judged by a human expert as creative, the agent is creative in his eyes.

Whether an imitation is a children's play or a hypothesis of a scientific principle depends on how experienced the imitator is. The more experienced the imitator is, typically the more valuable the imitation is.

Albert Einstein's work on general relativity is a result of autonomous imitations through trial and error. Similarly, all physical experiments that verified the relativity theory are also autonomous imitations. However, the former is harder because the gap from the 3D events (published physics experiments that Albert Einstein had learned then) to the created program (the relativity theory paper) is significantly wider than the latter (from the published relativity paper to a plan to verify the correctness). Therefore, research awards should not be based on primarily how complete an experiment is, but on also how large the gap is between prior arts and a novel result and its impact.

From the proof of Theorem 8, we can also see that human or machine imitations can be creative but never complete in fully understanding the real-world environment because imitations can be judged incorrect by some experts.

### XIV. EXAMPLE OF A CONSCIOUS-LEARNING ROBOT

The material presented here is only an example of the task-nonspecific method above that is applicable to any task that a robot body is capable of carrying out. To facilitate understanding, let us consider training a driverless car. Imagine this robot car is like a horse that will drive you autonomously and safely.

1) Sensors whose receptors fill the sensory area X.
a) Stereo cameras: A front view pair, f-cam, mounted on a pan-tilt head. The pan-tilt head pans over 180° for side-way traffics. A back view stereo camera, b-cam, looks at the human deriver to check his alertness. (Optionally, use three fixed stereo-camera pairs, f-cam, 1-cam, r-cam, with a higher hardware cost and three larger DNs because attention spreads wider if the camera is fixed.)
b) Stereo microphones, one pair for each pair of the stereo cameras.
c) Joystick wherein each button is a sensor.
d) Sonars and other sensors that come with the car.

2) Effectors whose muscles fill the motor area Z.
a) Steering
b) Acceleration
c) Braking
d) Speaking, developed from CCIPCA [57] for conscious prosody.
e) Other effectors that come with the car.

3) Hidden area Y: Two mobile phones running GPUs (preferably with dedicated FGPA or ASIC chip for DN), one for f-cam and b-cam respectively. Every phone is connected to its own stereo cameras and stereo microphones, but with all the effectors. The network update rate should be fast enough for the response time to come to a full stop after braking.

4) Innate sensorimotor behaviors as (x, z) pairs, x being associated with z, trained before birth from a none context. The input x for innate behaviors involves only simple sensors like joystick buttons, zero vectors for cameras and microphones, so that you can “pull” your car using the joystick like pulling a horse. Such innate behaviors are not hardwired, but learned by the DN before birth so that the robot is still autonomous right after the birth. All innate behaviors at birth may cause the car to collide with obstacles if you force them right after birth, but not necessarily so in later life.
a) Couple the “forward” graded value on the direction pad of the joystick with the acceleration force.
b) Couple the ‘backward” graded value on the direction pad on the joystick with the braking force.
c) Couple the “left” the graded value on the direction pad on the joystick with the left force on the steering wheel.
d) Couple the “right” the graded value on the direction pad on the joystick with the right force on the steering wheel.
e) Couple other buttons to the corresponding effectors, including desired direction from GPS and the pan-tilt head.
f) Associate at least one pain button and a sweet button on joystick as serotonin and dopamine. More buttons, one pair on each effector, are better for better belongingness—which reinforcer is for what effector.

5) Birth and live: the real-world environment provides complex x from cameras and microphones, the motor z starts with innate behaviors, and the DN starts to learn from its innate behaviors. Simple to complex autonomous imitations take place without a need for sensorimotor training, annotations for sensory inputs, and reinforcers.
a) Off-traffic: Use sensorimotor training based on Theorem 6 and then autonomous imitation based on Theorems 7 and 8. Early living experience enjoys a high plasticity of neurons which amounts to imprinting. Show yourself in the f-cam and b-cam so that you are imprinted into each DN network. Use your joystick buttons to teach the robot car how to respond to your personalized gestures to call the robot car to you, to wait at a proper distance and position and to park itself, like training a horse [3], [1].
b) Sensorimotor in traffic: Train the robot car using the motor-imposed mode, based on Theorems 6. You drive and let the robot learn during which the DN finds which scene features need what motor signals. It attends, thinks, rehearses, and compares its covert motor with yours.
c) Autonomous imitation in traffic: Set the robot motor free based on Theorems 7 and 8. Increasingly more sophisticated imitations take place which enable more sophisticated conscious learning by the robot car.
   Use approach and retreat techniques; desensitize and treat appropriately like training a horse [3], [1]. Conduct test sessions with sparse reinforcers. When it is mature, the robot may correct your human errors when you are distracted. Thus, driving by a mature robot car could be safer than you drive yourself as you can be more likely distracted than this smaller-brain machine.

After a company has trained and tested its conscious-learning robot car properly, download its trained DN and upload the DN onto many other robot cars with the same body and sell them as trained and reliable chauffeurs to its customers. Upload the trained DN onto robot cars with different bodies as starting DNs before further training or autonomous practice for adaptation to new robot-bodies. Customers may personalize their purchased robot cars according to their own need.

Robot schools are schools that specialize in training conscious learning robots for their customers. This will be a new business.

### REFERENCES

[1] C. Anderson. Clinton Anderson: Training a rescue horse, parts 1 to 13. DUHorseman Channel, YouTube, 2016.
[2] S. Arora. Polynomial time approximation schemes for euclidean traveling salesman and other geometric problems. Journal of the ACM, 45(5):753-782, 1998.
[3] Lynda Birke. Talking about horses: Control and freedom in the world of “Natural Horsemanship”. Society & Animals, 16(2):107-126, Jan. 1, 2008.
[4] M. Cole and S. R. Cole. The Development of Children. Freeman, New York, 3rd edition, 1996.
[5] N. D. Daw, S. Kakade, and P. Dayan. Opponent interactions between serotonin and dopamine. Neural Networks, 15(4-6):603-616, 2002.
[6] Q. Guo, X. Wu, and J. Weng. Cross-domain and within-domain synaptic maintenance for autonomous development of visual areas. In Proc. the Fifth Joint IEEE International Conference on Development and Learning and on Epigenetic Robotics, pages +1-6, Providence, R.I., Aug. 13-16, 2015.
[7] E. H. Hess. Imprinting: Early Experience and the Developmental Psychobiology of Attachment. Van Nostrand Reinhold Company, New York, 1973.
[8] J. E. Hoperoft, R. Motwani, and J. D. Ullman. Introduction to Automata Theory, Languages, and Computation. Addison-Wesley, Boston, Mass., 2006.
[9] A. Hussein, M. M. Gaber, E. Elyan, and C. Jayne. Imitation learning: A survey of learning methods. ACM Computing Surveys, 50:1-35, June 2017.
[10] P. N. Johnson-Laird. Human and machine thinking. Lawrence Erlbaum, Hillsdale, N.J., 1993.
[11] S. Kakade and P. Dayan. Dopamine: generalization and bonuses. Neural Network, 15:549-559, 2002.
[12] A. Karpathy, G. Toderici, S. Shetty, T. Leung, R. Sukthankar, and Li Fei-Fei. Large-scale video classification with convolutional neural networks. In Proc. Computer Vision and Pattern Recognition, pages +1-8, Columbus, Ohio, Jun. 24-27, 2014.
[13] C. Koch. What is consciousness? Scientific American, 318(6):60-64, June 2018.
[14] S. Koenig and R. G. Simmons. A robot navigation architecture based on partially observable markov decision process models. In D. Kortenkamp, R. Bonasso, and R. Murphy, editors, Artificial Intelligence Based Mobile Robotics: Case Studies of Successful Robot Systems, pages 91-122. MIT Press, Cambridge, Mass., 1998.
[15] A. Krizhevsky, I. Sutskever, and G. E. Hinton. Imagenet classification with deep convolutional neural networks. In Advances in Neural Information Processing Systems 25, pages 1106-1114, 2012.
[16] Y. LeCun, L. Bengio, and G. Hinton. Deep learning. Nature, 521:436-444, 2015.
[17] Y. LeCun, L. Bottou, Y. Bengio, and P. Haffner. Gradient-based learning applied to document recognition. Proceedings of IEEE, 86(11):2278-2324, 1998.
[18] J. C. Martin. Introduction to Languages and the Theory of Computation. McGraw Hill, Boston, Mass., 3rd edition, 2003.
[19] J. C. Martin. Introduction to Languages and the Theory of Computation. McGraw Hill, New York, 4th edition, 2011.
[20] A. N. Meltzoff and M. K. Moore. Imitation of facial and manual gestures by human neonates. Science, 198, Oct. 7, 1977.
[21] V. Mnih, K. Kavukcuoglu, D. Silver, A. A. Rusu, J. Veness, M. G. Bellemare, A. Graves, M. Riedmiller, A. K. Fidjeland, G. Ostrovski, S. Petersen, C. Beattie, A. Sadik, I. Antonoglou, H. King, D. Kumaran, D. Wierstra, S. Legg, and D. Hassabis. Human-level control through deep reinforcement learning. Nature, 518:529-533, 2015.
[22] S. Pinker. The Language Instinct: How the Mind Creates Language. William Morrow, New York, 1994.
[23] V. Pratt. Thinking machines. Basil Blackwell, Oxford UK, 1987.
[24] M. L. Puterman. Markov Decision Processes. Wiley, New York, 1994.
[25] M. Riesenhuber and T. Poggio. Hierarchical models of object recognition in cortex. Nature Neuroscience, 2(11):1019-1025, 1999.
[26] 0. Russakovsky, J. Deng, H. Su, J. Krause, S. Satheesh, S. Ma, Z. Huang, A. Karpathy, A. Khosla, M. Bernstein, A. C. Berg, and L. Fei-Fei. ImageNet large scale visual recognition challenge. International Journal of Computer Vision, 115:211-252, 2015.
[27] A. P. Saygin, I. Cicekli, and V. Akman Turing test: 50 years later. Minds and Machines, 10(4):463-518, 2000.
[28] J. Schrittwieser, I. Antonoglou, T. Hubert, K. Simonyan, L. Sifre, S. Schmitt, A. Guez, E. Lockhart, D. Hassabis, T. Graepel, T. Lillicrap, and D. Silver. Mastering atari, go, chess and shogi by planning with a learned model. Science, 588(7839):604-609, 2020.
[29] T. Serre, L. Wolf, S. Bileschi, M. Riesenhuber, and T. Poggio. Robust object recognition with cortex-like mechanisms. IEEE Trans. Pattern Analysis and Machine Intelligence, 29(3):411-426, 2007.
[30] A. Silver. Deep blue's cheating move. Chess News, Feb. 19, 2015. https://en.chessbase.com/post/deep-blue-s-cheating-move.
[31] R. J. Sternberg, editor. Thinking and Problem Solving. Academic Press, San Diego, Calif., 1994. Chapters 1 and 2.
[32] R. S. Sutton and A. Barto. Reinforcement Learning. MIT Press, Cambridge, Mass., 1998.
[33] G. Theocharous and S. Mahadevan. Approximate planning with hierarchical partially observable markov decision processes for robot navigation. In IEEE Conference on Robotics and Automation, Washington, D.C., 2002.
[34] M. Tomasello. The role of joint attentional processes in early language development. Language Sciences, 10:69-88, 1988.
[35] M. Tomasello. Constructing a Language: A Usage-Based Theory of Language Acquisition. Harvard University Press, Cambridge, Mass., 2003.
[36] A. M. Turing. On computable numbers with an application to the Entscheidungsproblem. Proc. London Math. Soc., 2nd series, 42:230-265, 1936. A correction, ibid., 43, pp. 544-546.
[37] A. M. Turing. Computing machinery and intelligence. Mind, 59:433-460, October 1950.
[38] Y. Wang, X. Wu, and J. Weng. Synapse maintenance in the where-what network. In Proc. Int'l Joint Conference on Neural Networks, pages 2823-2829, San Jose, Calif., July 31-Aug. 5, 2011.
[39] J. Weng. Symbolic models and emergent models: A review. IEEE Trans. Autonomous Mental Development, 4(1):29-53, 2012.
[40] J. Weng. Brain as an emergent finite automaton: A theory and three theorems. International Journal of Intelligence Science, 5(2):112-131, 2015.
[41] J. Weng. Consciousness for a social robot is not piecemeal. IEEE CIS Autonomous Mental Development Newsletter, 12(1):10-11, 2015.
[42] J. Weng. Autonomous programming for general purposes: Theory. International Journal of Huamnoid Robotics, 17(4):1-36, August 2020.
[43] J. Weng. Conscious intelligence requires developmental autonomous programming for general purposes. In Proc. IEEE International Conference on Development and Learning and Epigenetic Robotics, pages 1-7, Valparaiso, Chile, Oct. 26-27, 2020.
[44] J. Weng. Did Turing Awards go to fraud? YouTube Video, Jun. 4, 2020. 1:04 hours, https://youtu.be/Rz6CF1Krx2k.
[45] J. Weng. Life is science (36): Did Turing Awards go to fraud? Facebook blog, March 8 2020. www.facebook.com/juyang.weng/posts/10158319020739783.
[46] J. Weng. A unified hierarchy for AI and natural intelligence through auto-programming for general purposes. Journal of Cognitive Science, 21:53-102, 2020.
[47] J. Weng. Machines develop consciousness through autonomous programming for general purposes (APFGP). In Springer Lecture Notes on Communication, Proc. of IJCAI Workshop on Human Brain and Artificial Intelligence, pages 1-17, Yokohama, Japan, Jan. 7, 2021.
[48] J. Weng. On post selections using test sets (PSUTS) in AI. In Proc. International Joint Conference on Neural Networks, pages 1-8, Shengzhen, China, Jul. 18-22, 2021.
[49] J. Weng, N. Ahuja, and T. S. Huang. Cresceptron: a self-organizing neural network which grows adaptively. In Proc. Int'l Joint Conference on Neural Networks, volume 1, pages 576-581, Baltimore, Md., June 1992.
[50] J. Weng, N. Ahuja, and T. S. Huang. Learning recognition and segmentation of 3-D objects from 2-D images. In Proc. IEEE 4th Int'l Conf. Computer Vision, pages 121-128, May 1993.
[51] J. Weng, N. Ahuja, and T. S. Huang. Learning recognition and segmentation using the Cresceptron. International Journal of Computer Vision, 25(2):109-143, November 1997.
[52] J. Weng and M. Luciw. Dually optimal neuronal layers: Lobe component analysis. IEEE Trans. Autonomous Mental Development, 1(1):68-85, 2009.
[53] J. Weng, J. McClelland, A. Pentland, O. Sporns, I. Stockman, M. Sur, and E. Thelen. Autonomous mental development by robots and animals. Science, 291(5504):599-600, 2001.
[54] J. Weng, Z. Zheng, and X. Wu. Developmental Network Two, its optimality, and emergent Turing machines. U.S. Provisional Patent Application Ser. No.: 62/624,898, Feb. 1, 2018. Published.
[55] D. J. Wood, J. S. Bruner, and G. Ross. The role of tutoring in problem-solving. Journal of Child Psychology and Psychiatry, pages 89-100, 1976.
[56] M. A. Woodin, K. Ganguly, and M. M. Poo. Coincident pre- and postsynaptic activity modifies gabaergic synapses by postsynaptic changes in cl-transporter activity. Neuron, 39:807-820, 2003.
[57] X. Wu and J. Weng. Muscle vectors as temporally “Dense Labels”. In Proc. International Joint Conference on Neural Networks, pages 1-8, Glasgow, UK, Jul. 19-24, 2020.
[58] X. Wu and J. Weng. On machine thinking In Proc. International Joint Conf. Neural Networks, pages 1-8, Shenzhen, China, Jul. 18-22, 2021. IEEE Press.
[59] J. You. Beyond the Turing Test. Science, 247(6218):116, January 2015.
[60] A. J. Yu and P. Dayan. Uncertainty, neuromodulation, and attention. Neuron, 46:681-692, 2005.
[61] Y. Zhang and J. Weng. Task transfer by a developmental robot. IEEE Transactions on Evolutionary Computation, 11(2):226-248, 2007.

What is claimed is:

1) an annotation-free learning robot implemented in computer hardware comprising at least one neural network having a plurality of neurons organized into a hierarchy of levels comprising an X area associated with sensory information, a Z area associated with motor information, and a hidden Y area between the X area and the Z area, the improvement comprising sensory images and motor images are annotation-free during a learning process.

2) The improvement of claim 1, wherein attention to a sensory image is a result of neuronal competitions in the neural network so that only firing neurons represent a current attention the neuron's corresponding sensory receptive fields/patterns and to the neuron's corresponding motor receptive fields/patterns.

3) The improvement of claim 1, wherein the robot conducts “on the fly” learning to take advantage of sensorimotor recurrence of the robot's physical world.

4) The improvement of claim 1, wherein the robot conducts imprinting learning during which neurons in the neural networks are young and the network's learning is fast.

5) The improvement of claim 1, wherein the robot conducts sensorimotor learning from its 3D world via its 2D sensory images and motor images, called 3D-to-2D, to update the neural network.

6) The improvement of claim 1, wherein the robot conducts imitation learning, via its 2D sensory images and motor images but without 2D supervision, called 3D-to-2D-to-3D, to update the neural network.

7) The improvement of claims 4 to 6, where which mode—imprinting, sensorimotor, or imitation—is determined by the robot's external world which may include teachers.

8) The improvement of claim 1, wherein the robot conducts autonomous programming for general purposes by learning an emergent universal Turing machine in the neural network.

9) The improvement of claim 1, wherein the robot conducts machine thinking as updates of the neural network and wherein the thinking process corresponds to a sequence of context transitions in terms of an emergent Turing machine.

10) The improvement of claim 9, wherein neurons in a motor area Z consists of overt neurons and overt neurons.

11) The improvement of claim 10, wherein a thinking process reduces complexity of learning from an exponential complexity O(kⁿ) in n down to O(kn) using multi-stage abstraction realized by dynamic matching of motor context images.

12) The improvement of claim 11, wherein the robot chains its thoughts as context chaining using emergent Sub-Turing Machines implemented by the neural network.

13) The improvement of claim 12, wherein a winner context of a sub-Turing-machine calls the sub-Turing-machine.

14) The improvement of claim 13, wherein a grand emergent Turing machine inside the neural network automatically links and combines emergent Sub-Turing Machines into a grand universal Turing machine.

15) The improvement of claim 14, wherein an general-purpose emergent universal Turing machine in the neural network is taught to think in any tasks if the tasks have been learned in the form of sensors and effectors of the robot.

16) The improvement of claim 15, wherein the robot learns and conducts a plan as an example of general-purpose thinking.

17) The improvement of claim 1, where the neural network is motivated to deal with pains, sweets, or synaptic maintenance so that statistically well-matched input connections grow and statistically badly-matched input connections are cut.

18) The improvement of claim 1, wherein the neural network is always optimal in a sense of maximum likelihood under three learning conditions—an incremental learning framework, a limited computational resource, and a limited learning experience.

19) A utilization of claim 1 wherein the robot becomes increasingly conscious of rich information as a common dictionary definition for consciousness through conscious learning, where an early learned simpler consciousness facilities a later learning of more complex consciousness.

20) A conscious learning robot wherein the robot discovers new ideas through single-motor (or early) imitations and multiple-motor (or later) imitations and wherein such imitations are of general purposes without a need for motor impositions.
